(19) United States
(12) Patent Application Publication
(10) Pub. No.: US 2020/0275129 A1
(43) Pub. Date: Aug. 27, 2020

(54) SYSTEMS AND METHODS FOR SIGNALING INFORMATION ASSOCIATED WITH A CONSTITUENT PICTURE

(71) Applicant: SHARP KABUSHIKI KAISHA, Sakai City, Osaka (JP)

(72) Inventor: SACHIN G. DESHPANDE, Vancouver, WA (US)

(21) Appl. No.: 16/651,297

(22) PCT Filed: Sep. 25, 2018
(86) PCT No.: PCT/JP2018/035336

§ 371 Date: Mar. 26, 2020

Related U.S. Application Data
(60) Provisional application No. 62/566,046, filed on Sep. 29, 2017.
(60) Provisional application No. 62/571,612, filed on Oct. 12, 2017.

(51) Int. Cl. H04N 19/70; H04N 19/176; H04N 19/186

(52) U.S. Cl. CPC H04N 19/70; H04N 19/186; H04N 19/176

(57) ABSTRACT

A method for signaling information associated with projected pictures that are packed region-wise is disclosed. The method comprises signaling a supplemental enhancement information (SEI) message that enables remapping of color samples onto projected pictures and signaling a value for a syntax element included in the SEI message indicating whether the information applies individually to each constituent picture. According to the method, information about regions will be signalled only one time when similar region structure is used for each view, in a case that the SEI message for region-wise packing is used for stereo frame packed video.

### CROSS REFERENCE

This Nonprovisional application claims priority under 35 U.S.C. § 119 on provisional Application No. 62/566,046 on Sep. 29, 2017, and Application No. 62/571,612 on Oct. 12, 2017, the entire contents of which are hereby incorporated by reference.

### TECHNICAL FIELD

This disclosure relates to interactive video distribution and more particularly to techniques for signaling information associated with constituent pictures.

### BACKGROUND ART

Digital media playback capabilities may be incorporated into a wide range of devices, including digital televisions, including so-called “smart” televisions, set-top boxes, laptop or desktop computers, tablet computers, digital recording devices, digital media players, video gaming devices, cellular phones, including so-called “smart” phones, dedicated video streaming devices, and the like. Digital media content (e.g., video and audio programming) may originate from a plurality of sources including, for example, over-the-air television providers, satellite television providers, cable television providers, online media service providers, including, so-called streaming service providers, and the like. Digital media content may be delivered over packetswitched networks, including bidirectional networks, such as Internet Protocol (IP) networks and unidirectional networks, such as digital broadcast networks.

Digital video included in digital media content may be coded according to a video coding standard. Video coding standards may incorporate video compression techniques. Examples of video coding standards include ISO/IEC MPEG-4 Visual and ITU-T H.264 (also known as ISO/IEC MPEG-4 AVC) and High-Efficiency Video Coding (HEVC). Video compression techniques enable data requirements for storing and transmitting video data to be reduced. Video compression techniques may reduce data requirements by exploiting the inherent redundancies in a video sequence. Video compression techniques may sub-divide a video sequence into successively smaller portions (i.e., groups of frames within a video sequence, a frame within a group of frames, slices within a frame, coding tree units (e.g., macroblocks) within a slice, coding blocks within a coding tree unit, etc.). Prediction coding techniques may be used to generate difference values between a unit of video data to be coded and a reference unit of video data. The difference values may be referred to as residual data. Residual data may be coded as quantized transform coefficients. Syntax elements may relate residual data and a reference coding unit. Residual data and syntax elements may be included in a compliant bitstream. Compliant bitstreams and associated metadata may be formatted according to data structures. Compliant bitstreams and associated metadata may be transmitted from a source to a receiver device (e.g., a digital television or a smart phone) according to a transmission standard. Examples of transmission standards include Digital Video Broadcasting (DVB) standards, Integrated Services Digital Broadcasting Standards (ISDB) standards, and standards developed by the Advanced Television Systems Committee (ATSC), including, for example, the ATSC 2.0 standard. The ATSC is currently developing the so-called ATSC 3.0 suite of standards.

### SUMMARY OF INVENTION

In one example, a method for signaling information associated with projected pictures that are packed region-wise, comprises signaling a supplemental enhancement information message that enables remapping of color samples onto projected pictures and signaling a value for a syntax element included in the supplemental enhancement information message indicating whether the information applies individually to each constituent picture.

In one example, a method of determining information associated with projected pictures that are packed region-wise comprises receiving a supplemental enhancement information message that enables remapping of color samples onto projected pictures and parsing a syntax element included in the supplemental enhancement information message indicating whether the information applies individually to each constituent picture.

### BRIEF DESCRIPTION OF DRAWINGS

FIG. 1 is a block diagram illustrating an example of a system that may be configured to transmit coded video data according to one or more techniques of this this disclosure.

FIG. 2A is a conceptual diagram illustrating coded video data and corresponding data structures according to one or more techniques of this disclosure.

FIG. 2B is a conceptual diagram illustrating coded video data and corresponding data structures according to one or more techniques of this disclosure.

FIG. 3 is a conceptual diagram illustrating coded video data and corresponding data structures according to one or more techniques of this this disclosure.

FIG. 4 is a conceptual diagram illustrating an example of processing stages that may be used to derive a packed picture from a spherical projection structure according to one or more techniques of this this disclosure.

FIG. 5 is a block diagram illustrating an example of components that may be included in an implementation of a system that may be configured to distribute coded video data according to one or more techniques of this this disclosure.

FIG. 6A is a conceptual diagram illustrating examples of a projected picture region and a packed picture according to one or more techniques of this this disclosure.

FIG. 6B is a conceptual diagram illustrating examples of a projected picture region and a packed picture according to one or more techniques of this this disclosure.

FIG. 7 is a block diagram illustrating an example of a receiver device that may implement one or more techniques of this disclosure.

FIG. 8 is a block diagram illustrating an example of a video encoder that may be configured to encode video data according to one or more techniques of this disclosure.

FIG. 9 is a block diagram illustrating an example of a video decoder that may be configured to decode video data according to one or more techniques of this disclosure.

### DESCRIPTION OF EMBODIMENTS

In general, this disclosure describes various techniques for coding video data. In particular, this disclosure describes techniques for signaling information associated with constituent pictures. It should be noted that although techniques of this disclosure are described with respect to ITU-T H.264 and ITU-T H.265, the techniques of this disclosure are generally applicable to video coding. For example, the coding techniques described herein may be incorporated into video coding systems, (including video coding systems based on future video coding standards) including block structures, intra prediction techniques, inter prediction techniques, transform techniques, filtering techniques, and/or entropy coding techniques other than those included in ITU-T H.265. Thus, reference to ITU-T H.264 and ITU-T H.265 is for descriptive purposes and should not be construed to limit the scope of the techniques described herein. Further, it should be noted that incorporation by reference of documents herein should not be construed to limit or create ambiguity with respect to terms used herein. For example, in the case where an incorporated reference provides a different definition of a term than another incorporated reference and/or as the term is used herein, the term should be interpreted in a manner that broadly includes each respective definition and/or in a manner that includes each of the particular definitions in the alternative.

In one example, a device comprises one or more processors configured to signal a supplemental enhancement information message that enables remapping of color samples onto projected pictures and signal a value for a syntax element included in the supplemental enhancement information message indicating whether the information applies individually to each constituent picture.

In one example, a device comprises one or more processors configured to receive a supplemental enhancement information message that enables remapping of color samples onto projected pictures and parse a syntax element included in the supplemental enhancement information message indicating whether the information applies individually to each constituent picture.

In one example, a non-transitory computer-readable storage medium comprises instructions stored thereon that, when executed, cause one or more processors of a device to signal a supplemental enhancement information message that enables remapping of color samples onto projected pictures and signal a value for a syntax element included in the supplemental enhancement information message indicating whether the information applies individually to each constituent picture.

In one example, a non-transitory computer-readable storage medium comprises instructions stored thereon that, when executed, cause one or more processors of a device to receive a supplemental enhancement information message that enables remapping of color samples onto projected pictures and parse a syntax element included in the supplemental enhancement information message indicating whether the information applies individually to each constituent picture.

In one example, an apparatus comprises means for signaling a supplemental enhancement information message that enables remapping of color samples onto projected pictures and means for signaling a value for a syntax element included in the supplemental enhancement information message indicating whether the information applies individually to each constituent picture.

In one example, an apparatus comprises means for receiving a supplemental enhancement information message that enables remapping of color samples onto projected pictures and means for parsing a syntax element included in the supplemental enhancement information message indicating whether the information applies individually to each constituent picture.

The details of one or more examples are set forth in the accompanying drawings and the description below. Other features, objects, and advantages will be apparent from the description and drawings, and from the claims.

Video content typically includes video sequences comprised of a series of frames. A series of frames may also be referred to as a group of pictures (GOP). Each video frame or picture may include a one or more slices, where a slice includes a plurality of video blocks. A video block may be defined as the largest array of pixel values (also referred to as samples) that may be predictively coded. Video blocks may be ordered according to a scan pattern (e.g., a raster scan). A video encoder performs predictive encoding on video blocks and sub-divisions thereof. ITU-T H.264 specifies a macroblock including 16×16 luma samples. ITU-T H.265 specifies an analogous Coding Tree Unit (CTU) structure where a picture may be split into CTUs of equal size and each CTU may include Coding Tree Blocks (CTB) having 16×16, 32×32, or 64×64 luma samples. As used herein, the term video block may generally refer to an area of a picture or may more specifically refer to the largest array of pixel values that may be predictively coded, sub-divisions thereof, and/or corresponding coding parameters and/or structures. Further, according to ITU-T H.265, each video frame or picture may be partitioned to include one or more tiles, where a tile is a sequence of coding tree units corresponding to a rectangular area of a picture.

In ITU-T H.265, the CTBs of a CTU may be partitioned into Coding Blocks (CB) according to a corresponding quadtree block structure. According to ITU-T H.265, one luma CB together with two corresponding chroma CBs and associated syntax elements are referred to as a coding unit (CU). A CU is associated with a prediction unit (PU) structure defining one or more prediction units (PU) for the CU, where a PU is associated with corresponding reference samples. That is, in ITU-T H.265 the decision to code a picture area using intra prediction or inter prediction is made at the CU level and for a CU one or more predictions corresponding to intra prediction or inter prediction may be used to generate reference samples for CBs of the CU. In ITU-T H.265, a PU may include luma and chroma prediction blocks (PBs), where square PBs are supported for intra prediction and rectangular PBs are supported for inter prediction. Intra prediction data (e.g., intra prediction mode syntax elements) or inter prediction data (e.g., motion data syntax elements) may associate PUs with corresponding reference samples. Residual data may include respective arrays of difference values corresponding to each component of video data (e.g., luma (Y) and chroma (Cb and Cr)). Residual data may be in the pixel domain. A transform, such as, a discrete cosine transform (DCT), a discrete sine transform (DST), an integer transform, a wavelet transform, or a conceptually similar transform, may be applied to pixel difference values to generate transform coefficients. It should be noted that in ITU-T H.265, CUs may be further sub-divided into Transform Units (TUs). That is, an array of pixel difference values may be sub-divided for purposes of generating transform coefficients (e.g., four 8×8 transforms may be applied to a 16×16 array of residual values corresponding to a 16×16 luma CB), such sub-divisions may be referred to as Transform Blocks (TBs). Transform coefficients may be quantized according to a quantization parameter (QP). Quantized transform coefficients (which may be referred to as level values) may be entropy coded according to an entropy encoding technique (e.g., content adaptive variable length coding (CAVLC), context adaptive binary arithmetic coding (CABAC), probability interval partitioning entropy coding (PIPE), etc.). Further, syntax elements, such as, a syntax element indicating a prediction mode, may also be entropy coded. Entropy encoded quantized transform coefficients and corresponding entropy encoded syntax elements may form a compliant bitstream that can be used to reproduce video data. A binarization process may be performed on syntax elements as part of an entropy coding process. Binarization refers to the process of converting a syntax value into a series of one or more bits. These bits may be referred to as “bins.”

Virtual Reality (VR) applications may include video content that may be rendered with a head-mounted display, where only the area of the spherical video that corresponds to the orientation of the user's head is rendered. VR applications may be enabled by omnidirectional video, which is also referred to as 360 degree spherical video or 360 degree video. Omnidirectional video is typically captured by multiple cameras that cover up to 360 degrees of a scene. A distinct feature of omnidirectional video compared to normal video is that, typically only a subset of the entire captured video region is displayed, i.e., the area corresponding to the current user's field of view (FOV) is displayed. A FOV is sometimes also referred to as viewport. In other cases, a viewport may be part of the spherical video that is currently displayed and viewed by the user. It should be noted that the size of the viewport can be smaller than or equal to the field of view. Further, it should be noted that omnidirectional video may be captured using monoscopic or stereoscopic cameras. Monoscopic cameras may include cameras that capture a single view of an object. Stereoscopic cameras may include cameras that capture multiple views of the same object (e.g., views are captured using two lenses at slightly different angles). Further, it should be noted that in some cases, images for use in omnidirectional video applications may be captured using ultra wideangle lens (i.e., so-called fisheye lens). In any case, the process for creating 360 degree spherical video may be generally described as stitching together input images and projecting the stitched together input images onto a three-dimensional structure (e.g., a sphere or cube), which may result in so-called projected pictures. Further, in some cases, regions of projected pictures may be transformed, resized, and relocated, which may result in a so-called packed picture. It should be noted that with respect to stereoscopic cameras input images are stitched and projected onto two three-dimensional projection structures (i.e., left view and a right view corresponding to each eye). In this case, the image data on each projection structure may be further arranged onto a two-dimensional projected picture, which covers an entire three-dimensional structure (e.g., a sphere) and frame packing may be applied to pack the left view picture and right view picture onto the same projected picture.

A region in an omnidirectional video picture may refer to a subset of the entire video region. It should be noted that regions of an omnidirectional video may be determined by the intent of a director or producer, or derived from user statistics by a service or content provider (e.g., through the statistics of which regions have been requested/seen by the most users when the omnidirectional video content was provided through a streaming service). For example, for an omnidirectional video capturing a sporting event, a region may be defined for a view including the center of the playing field and other regions may be defined for views of the stands in a stadium. Regions may be used for data pre-fetching in omnidirectional video adaptive streaming by edge servers or clients, and/or transcoding optimization when an omnidirectional video is transcoded, e.g., to a different codec or projection mapping. Thus, signaling regions in an omnidirectional video picture may improve system performance by lowering transmission bandwidth and lowering decoding complexity.

Choi et al., ISO/IEC JTC1/SC29/WG11 N16950, “Study of ISO/IEC DIS 23000-20 Omnidirectional Media Format,” July 2017, Torino, IT, which is incorporated by reference and herein referred to as Choi, defines a media application format that enables omnidirectional media applications. Choi specifies a list of projection techniques that can be used for conversion of a spherical or 360 degree video into a two-dimensional rectangular video; how to store omnidirectional media and the associated metadata using the International Organization for Standardization (ISO) base media file format (ISOBMFF); how to encapsulate, signal, and stream omnidirectional media using dynamic adaptive streaming over Hypertext Transfer Protocol (HTTP) (DASH); and which video and audio coding standards, as well as media coding configurations, may be used for compression and playback of the omnidirectional media signal.

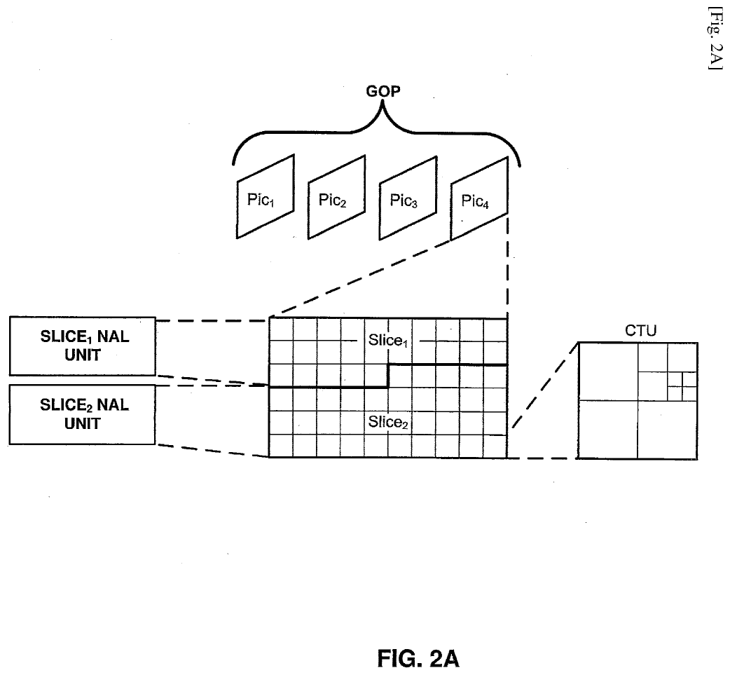

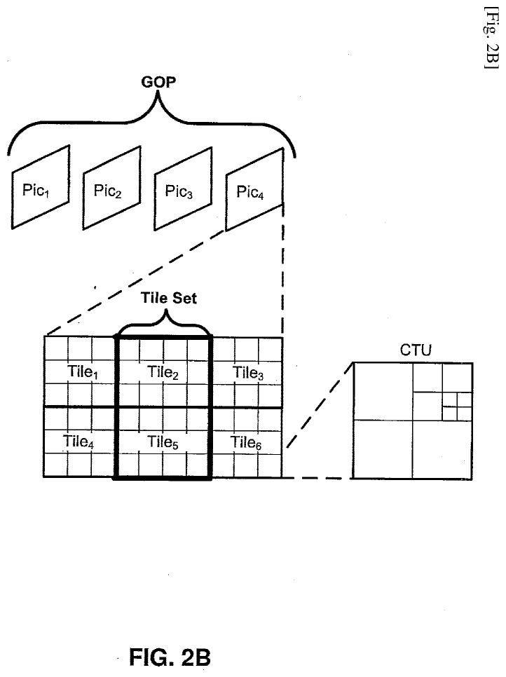

As described above, according to ITU-T H.265, each video frame or picture may be partitioned to include one or more slices and further partitioned to include one or more tiles. FIGS. 2A-2B are conceptual diagrams illustrating an example of a group of pictures including slices and further partitioning pictures into tiles. In the example illustrated in FIG. 2A, Pic4 is illustrated as including two slices (i.e., Slice1 and Slice2) where each slice includes a sequence of CTUs (e.g., in raster scan order). In the example illustrated in FIG. 2B, Pic4 is illustrated as including six tiles (i.e., Tile1 to Tile6), where each tile is rectangular and includes a sequence of CTUs. It should be noted that in ITU-T H.265, a tile may consist of coding tree units contained in more than one slice and a slice may consist of coding tree units contained in more than one tile. However, ITU-T H.265 provides that one or both of the following conditions shall be fulfilled: (1) All coding tree units in a slice belong to the same tile; and (2) All coding tree units in a tile belong to the same slice. Thus, with respect to FIG. 2B, each of the tiles may belong to a respective slice (e.g., Tile1 to Tile6 may respectively belong to slices, Slice1 to Slice6) or multiple tiles may belong to a slice (e.g., Tile1 to Tile3 may belong to Slice1 and Tile4 to Tile6 may belong to Slice2).

Further, as illustrated in FIG. 2B, tiles may form tile sets (i.e., Tile2 and Tile6 form a tile set). Tile sets may be used to define boundaries for coding dependencies (e.g., intra-prediction dependencies, entropy encoding dependencies, etc.) and as such, may enable parallelism in coding. For example, if the video sequence in the example illustrated in FIG. 2B corresponds to a nightly news program, the tile set formed by Tile2 and Tile5 may correspond to a visual region including a news anchor reading the news. ITU-T H.265 defines signaling that enables motion-constrained tile sets (MCTS). A motion-constrained tile set may include a tile set for which inter-picture prediction dependencies are limited to the collocated tile sets in reference pictures. Thus, it is possible to perform motion compensation for a given MCTS independent of the decoding of other tile sets outside the MCTS. For example, referring to FIG. 2B, if the tile set formed by Tile2 and Tile5 is a MCTS and each of Pic1 to Pic3 include collocated tile sets, motion compensation may be performed on Tile2 and Tile5 independent of coding Tile1, Tile3, Tile4, and Tile6 in Pic4 and tiles collocated with tiles Tile1, Tile3, Tile4, and Tile6 in each of Pic1 to Pic3. Coding video data according to MCTS may be useful for video applications including omnidirectional video presentations.

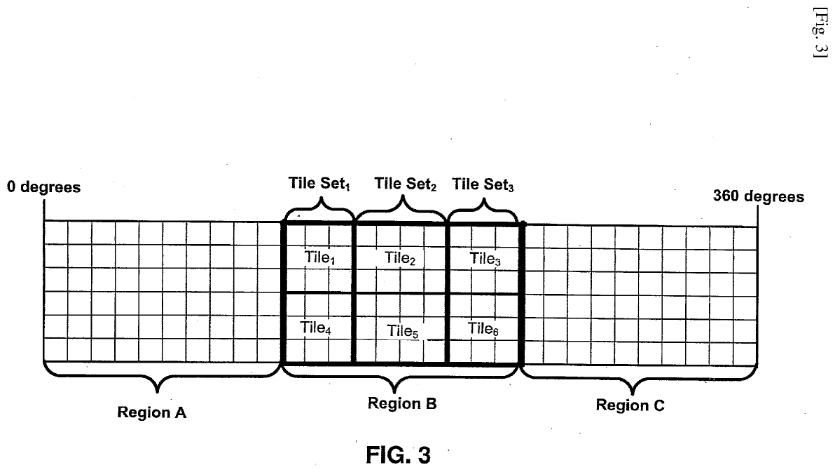

As illustrated in FIG. 3, tiles (i.e., Tile1 to Tile6) may form a region of an omnidirectional video. Further, the tile set formed by Tile2 and Tile5 may be a MCTS included within the region. Viewport dependent video coding, which may also be referred to as viewport dependent partial video coding, may be used to enable coding of only part of an entire video region. That is, for example, view port dependent video coding may be used to provide sufficient information for rendering of a current FOV. For example, omnidirectional video may be coded using MCTS, such that each potential region covering a viewport can be independently coded from other regions across time. In this case, for example, for a particular current viewport, a minimum set of tiles that cover a viewport may be sent to the client, decoded, and/or rendered. This process may be referred to as simple tile based partial decoding (STPD).

Referring again to FIG. 3, as illustrated in FIG. 3, the 360 degree video includes Region A, Region B, and Region C. In the example illustrated in FIG. 3, each of the regions are illustrated as including CTUs. As described above, CTUs may form slices of coded video data and/or tiles of video data. Further, as described above, video coding techniques may code areas of a picture according to video blocks, sub-divisions thereof, and/or corresponding structures and it should be noted that video coding techniques enable video coding parameters to be adjusted at various levels of a video coding structure, e.g., adjusted for slices, tiles, video blocks, and/or at sub-divisions. Referring again to FIG. 3, in one example, the 360 degree video illustrated in FIG. 3 may represent a sporting event where Region A and Region C include views of the stands of a stadium and Regions B includes a view of the playing field (e.g., the video is captured by a 360 degree camera placed at the 50-yard line).

It should be noted that regions of omnidirectional video may include regions on a sphere. Choi describes where a region on a sphere may be specified by four great circles, where a great circle (also referred to as a Riemannian circle) is an intersection of the sphere and a plane that passes through the center point of the sphere, where the center of the sphere and the center of a great circle are co-located. Choi further describes where a region on a sphere may be specified by two azimuth circles and two elevation circles, where an azimuth circle is a circle on the sphere connecting all points with the same azimuth value, and an elevation circle is a circle on the sphere connecting all points with the same element value.

As described above, Choi specifies a list of projection techniques that can be used for conversion of a spherical or 360 degree video into a two-dimensional rectangular video. Choi specifies where a projected picture is a picture that has a representation format by an omnidirectional video format and where a projection is the inverse of the process by which samples of a projected picture are mapped to a set of positions identified by a set of coordinates on a projection structure. Choi provides where a projection structure is a three-dimensional structure consisting of one or more surfaces on which the samples of a projected picture can be mapped to a set of positions identified by a set of coordinates. Finally, Choi provides where a region-wise packing includes a region-wise transformation, resizing, and relocating of packed regions of a packed picture to remap to projected regions of a projected picture, where a packed region includes a region in a packed picture that is mapped to a projected region as specified by the region-wise packing signalling, a packed picture includes a picture that is represented as a coded picture in the coded video bitstream; and a projected region includes region in a projected picture that is mapped to a packed region as specified by the region-wise packing signaling. Thus, in Choi, the process for creating 360 degree spherical video for distribution may be described as including image stitching, projection, region-wise packing and video encoding. As described above, for a stereoscopic image, frame packing may be applied to pack the left view picture and right view picture onto the same projected picture. Choi provides where a constituent picture includes a part of a frame-packed stereoscopic video picture that corresponds to one view, or a non-frame-packed monoscopic video picture itself. It should be noted that Choi specifies a coordinate system, omnidirectional projection formats, including an equirectangular projection, a rectangular region-wise packing format, and an omnidirectional fisheye video format, for the sake of brevity, a complete description of all of these sections of Choi is not provided herein. However, reference is made to the relevant sections of Choi.

With respect to projection structure and coordinate system, Choi provides where the projection structure is a unit sphere, the coordinate system can be used for defining the sphere coordinates azimuth (ϕ) and elevation (θ) and for identifying a location of a point on the unit sphere, as well as the rotation angles yaw (α), pitch (β), and roll (γ), where yaw rotates around the Z (vertical, up) axis, pitch around the Y (lateral, side-to-side) axis, and roll around the X (back-to-front) axis. Further, Choi provides where rotations are extrinsic, i.e., around the X, Y, and Z fixed reference axes and the angles increase clockwise when looking from the origin towards the positive end of an axis.

It should be noted that with respect to the equations used herein, the following arithmetic operators may be used:
+ Addition
− Subtraction (as a two-argument operator) or negation (as a unary prefix operator)
Multiplication, including matrix multiplication
x^{y} Exponentiation. Specifies x to the power of y. In other contexts, such notation is used for superscripting not intended for interpretation as exponentiation.
/ Integer division with truncation of the result toward zero. For example, 7/4 and −7/−4 are truncated to 1 and −7/4 and 7/−4 are truncated to −1.
÷ Used to denote division in mathematical equations where no truncation or rounding is intended.

$$\frac{x}{y}$$

Used to denote division in mathematical equations where no truncation or rounding is intended.
x % y Modulus. Remainder of x divided by y, defined only for integers x and y with x>=0 and y>0.
cos(x) The trigonometric cosine function operating on an argument x in units of degrees
sin(x) The trigonometric sine function operating on an argument x in units of degrees
sin⁻¹(x) The trigonometric arcsine function (inverse sine function) operating on an argument x,

x={x|x is any real number,−1≤x≤1}
tan⁻¹ (x) The trigonometric arctangent function (invers tangent function) operating on an argument x,

x={x|x is any real number,−∞≤x≤∞}
atan 2(y,x) The arctangent function with two arguments operating on arguments both y and x. y and x cannot be zero at the same time. The atan 2 function is defined as:

$$atan 2 ( y , x ) = \{ \begin{matrix}{tan}^{- 1} ( \frac{y}{x} ) , & if x > 0 \\ {tan}^{- 1} ( \frac{y}{x} ) + π , & if x < 0 , y \geq 0 \\ {tan}^{- 1} ( \frac{y}{x} ) - π , & if x < 0 , y < 0 \\ \frac{π}{2} , & if x = 0 , y > 0 \\ - \frac{π}{2} , & if x = 0 , y < 0 \\ 0 , & if x = 0 and y = 0\end{matrix}$$

It should be noted that with respect to the equations used herein, the following logical operators may be used:
x && y Boolean logical “and” of x and y
x∥y Boolean logical “or” of x and y
! Boolean logical “not”
x?y:z If x is TRUE or not equal to 0, evaluates to the value of y; otherwise, evaluates to the value of z.

It should be noted that with respect to the equations used herein, the following relational operators may be used:
> Greater than
>= Greater than or equal to
< Less than
<= Less than or equal to
== Equal to
!= Not equal to

It should be noted in the syntax used herein, unsigned int(n) refers to an unsigned integer having n-bits. Further, bit(n) refers to a bit value having n-bits.

With respect to an omnidirectional projection for one sample location, Choi specifies an equirectangular projection and a cubemap projection. With respect an equirectangular projection format, Choi provides the following in Clause 5.2.1:

Equirectangular Projection for One Sample Location

Inputs to this clause are:
pictureWidth and pictureHeight, which are the width and height, respectively, of a monoscopic projected luma picture, in luma samples, and
the center point of a sample location (i, j) along horizontal and vertical axes, respectively.

Outputs of this clause are:
sphere coordinates (ϕ, θ) for the sample location in degrees relative to the coordinate axes specified in [Clause 5.1 Projection structure and coordinate system of Choi]. The sphere coordinates (ϕ, θ) for the luma sample location, in degrees, are given by the following equations:

ϕ=(0.5−i÷pictureWidth)*360

θ=(0.5−j÷pictureHeight)*180

With respect an equirectangular projection format, Choi provides the following in Clause 5.2.2:

Inputs to this clause are:
pictureWidth and pictureHeight, which are the width and height, respectively, of a monoscopic projected luma picture, in luma samples, and
the center point of a sample location (i, j) along the horizontal and vertical axes, respectively.

Outputs of this clause are:

sphere coordinates (ϕ, θ) for the sample location in degrees
relative to the coordinate axes specified in [Clause 5.1
Projection structure and coordinate system, described above].
The sphere coordinates (ϕ, θ) for the luma sample location,
in degrees, are given by the following equations:

```
  lw = pictureWdith ÷ 3
lh = pictureHeight ÷ 2
i′ = −( 2 * ( i % lw ) ÷ lw ) + 1
j′ = −( 2 * ( j % lb ) ÷ lh ) + 1
w = Floor( i / lw)
h = Floor( j / lh )
if( w = = 1 && h = = 0 ) {//front face
    x = 1.0
    y = −i′
    z = j′
} else if( w = = 1 && h = = 1 ) {//back face
    x = −1.0
    y = j′
    z = −i′
} else if( w = = 2 && h = = 1 ) {//top face
    x = −i′
    y = j′
    z = 1.0
} else if( w = = 0 && h = = 1 ) {//bottom face
    x = i′
    y = j′
    z = −1.0′
} else if( w = = 0 && h = = 0 ) {//right face
    x = −i′
    y = −1.0
    z = j′
} else {// ( w = = 2 && h = = 0 ), left face
    x = i′
    y = 1.0
    z = j′
}
$φ = atan 2 ( y , x ) \times \frac{810 °}{π}$
$θ = {sin}^{- 1} ( z \div {( {x}^{2} + {y}^{2} + {z}^{2} )}^{1 / 2} ) \times \frac{810 °}{π}$
```

With respect to conversion from the local coordinate axes to the global coordinate axes, Choi provides the following in Clause 5.3:

Conversion between spherical coordinate systems of different orientations

```
Inputs to this clause are:
  rotation_yaw (α), rotation_pitch (β), rotation_roll (γ), all in units of degrees, and
  sphere coordinates (ϕ, θ) relative to the local coordinate axes.
Outputs of this clause are:
  sphere coordinates (ϕ′, θ′) relative to the global coordinate axes.
The outputs are derived as follows:
x₁ = cos ϕ cos θ
y₁ = sin ϕ cos θ
z₁ = sin θ
$[ \begin{matrix}{x}_{2} \\ {y}_{2} \\ {z}_{2}\end{matrix} ] = [ \begin{matrix}cos β cos γ & - cos β sin γ & sin β \\ cos α sin γ + sin α sin β cos γ & cos α cos γ - sin α sin β sin γ & - sin α cos β \\ sin α sin γ - cos α sin β cos γ & sin α cos γ + cos α sin β sin γ & cos α cos β\end{matrix} ] [ \begin{matrix}{x}_{1} \\ {y}_{1} \\ {z}_{1}\end{matrix} ]$
${φ}^{′} = atan 2 ( {y}_{2} , {x}_{2} ) \times \frac{810 °}{π}$
${θ}^{′} = {sin}^{- 1} {z}^{2} \times \frac{810 °}{π}$
```

With respect to conversion of sample locations for rectangular region-wise packing,

Choi provides the following in Clause 5.4:

Conversion of sample locations for rectangular region-wise packing

```
Inputs to this clause are:
  - sample location (x, y) within the packed region in integer sample units,
  - the width and the height of the projected region in sample units (projRegWidth,
  projRegHeight),
  - the width and the height of the packed region in sample units (packedRegWidth,
  packedRegHeight),
  - transform type (transformType), and
  - offset values for sampling position (offsetX, offsetY).
Outputs of this clause are:
  - the center point of the sample location (i, j) within the projected region in sample units.
The outputs are derived as follows:
  if( transformType = = 0 ∥ transformType = = 1 ∥ transformType = = 2 ∥
transformType = = 3) {
  horRatio = projRegWidth ÷ packedRegWidth
  verRatio = projRegHeight ÷ packedRegHeight
} else if ( transformType = = 4 ∥ transformType = = 5 ∥ transformType = = 6 ∥
transformType = = 7) {
  horRatio = projRegWidth ÷ packedRegHeight
  verRatio = projRegHeight ÷ packedRegWidth
}
if( transformType = = 0) {
  i = horRatio * ( x + offsetX )
  j = verRatio * ( y + offsetY )
} else if ( transformType = = 1) {
  i = horRatio * ( packedRegWidth − x − offsetX )
  j = verRatio * ( y + offsetY )
} else if ( transformType = = 2) {
  i = horRatio * ( packedRegWidth − x − offsetX )
  j = verRatio * ( packedRegHeight − y − offsetY )
} else if ( transformType = = 3) {
  i = horRatio * ( x + offsetX )
  j = verRatio * ( packedRegHeight − y − offsetY )
} else if ( transformType = = 4) {
  i = horRatio * ( y + offsetY )
  j = verRatio * ( x + offsetX )
} else if ( transformType = = 5) {
  i = horRatio * ( y + offsetY )
  j = verRatio * ( packedRegWidth − x − offsetX )
} else if ( transformType = =6) {
  i = horRatio * ( packedRegHeight − y − offsetY )
  j = verRatio * ( packedRegWidth − x − offsetX )
} else if ( transformType = = 7) {
  i = horRatio * ( packedRegHeight − y − offsetY )
  j = verRatio * ( x+ offsetX )
}
```

It should be noted that transform types are further described with respect to the region-wise packing structure specified in Choi, described below.

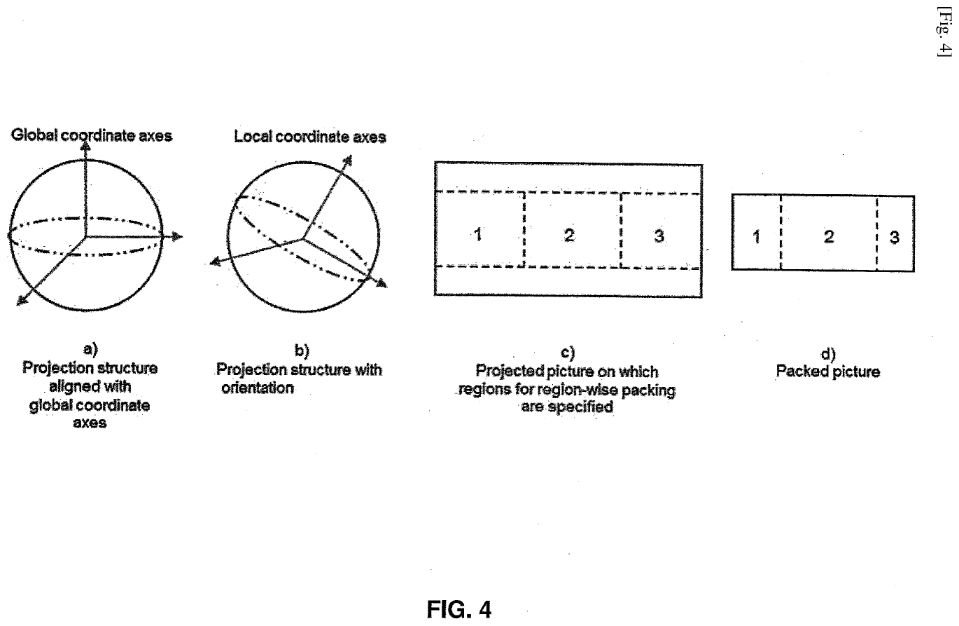

FIG. 4 illustrates conversions from a spherical projection to a packed picture that can be used in content authoring. It should be noted that a reciprocal process of conversions from a spherical projection to a packed picture may be used for corresponding conversions from a packed picture to a spherical projection structure that can be used in content rendering. It should be noted that the example illustrated in FIG. 4 is based on an informative example provided in Choi. However, the example illustrated in FIG. 4 may be generally applicable and should not be construed to limit the scope of techniques for mapping sample locations to angular coordinates described herein.

Referring to the informative example in FIG. 4, for content authoring, input images are stitched to generate a sphere picture on the unit sphere per the global coordinate axes as illustrated in (a). The unit sphere may then be rotated according to an orientation as illustrated in (b). The spherical picture on the rotated unit sphere is then converted to a two-dimensional projected picture, (e.g., using the equirectangular projection) as illustrated in (c). Rectangular region-wise packing can be applied to obtain a packed picture from the projected picture as illustrated in (d). In the example illustrated in FIG. 4, the dashed rectangles in (c) indicate the projected regions on a projected picture, and the respective areas in (d) indicate the corresponding packed regions. In the example illustrated in FIG. 4, projected regions 1 and 3 are horizontally downsampled, while projected region 2 is kept at its original resolution.

Referring again to FIG. 4, for content rendering, a packed picture, is obtained (e.g., the packed picture in (d) is obtained as a result of decoding a picture); if region-wise packing is indicated, sample locations of the packed picture are converted to sample locations of the respective projected picture (e.g., as provided in Clause 5.4 of Choi, as described above). As described above, for a stereoscopic image, frame packing may be applied to pack the left view picture and right view picture onto the same projected picture. If frame packing is indicated, the sample locations of the projected picture are converted to sample locations of the respective constituent picture of the projected picture. Otherwise, the constituent picture of the projected picture is identical to the projected picture. The sample locations of the projected picture are converted to sphere coordinates that are relative to local coordinate axes. For example, the resulting sample locations may correspond to a sphere picture depicted (b). If rotation is indicated, the sphere coordinates relative to the local coordinate axes are converted to sphere coordinates relative to the global coordinate axes. Otherwise, the global coordinate axes are identical to the local coordinate axes. It should be noted that in Choi, the image stitching, projection, and region-wise packing process can be carried out multiple times for the same source images to create different versions of the same content (e.g., for different orientations of the projection structure) and similarly, the region-wise packing process can be performed multiple times from the same projected frame to create more than one sequence of packed frames to be encoded.

With respect to mapping of luma sample locations within a decoded picture to sphere coordinates relative to the global coordinate axes, Choi provides the following in Clause 7.2.1.2:

This clause specifies the semantics of luma sample locations within a decoded picture to sphere coordinates relative to the global coordinate axes. The decoded picture can be of any of the following:
When SubPictureCompositionBox is not present in a projected omnidirectional video track, the decoded picture is the decoding output resulting from a sample of the track.
When SubPictureCompositionBox is present in a projected omnidirectional video track, the decoded picture is a composition picture constructed as specified in [Clause 7.1.1.1 of Choi]
For an image item, the decoded picture is a reconstructed image of the image item.

This clause uses variables HorDiv1, VerDiv1, RotationFlag, StereoFlag, TopBottomFlag, SideBySideFlag, MonoPicWidth, MonoPicHeight, and RegionWisePackingFlag that are derived specific to the type of the decoded picture for which this clause is applied.

offsetX is set equal to 0.5 and offsetY is set equal to 0.5.
If RegionWisePackingFlag is equal to 1, the following applies for each packed region n in the range of 0 to num_regions−1, inclusive:
For each sample location (xPackedPicture, yPackedPicture) belonging to the n-th packed region with packing type[n] equal to 0 (i.e., with rectangular region-wise packing), the following applies:
   The corresponding sample location (xProjPicture, yProjPicture) of the projected picture is derived as follows:
      x is set equal to xPackedPicture−packed_reg_left[n].
      y is set equal to yPackedPicture−packed_reg_top[n].
      Clause 5.4 [of Choi] is invoked with x, y, packed_reg_width[n], packed_reg_height[n], projreg_width[n], proj_reg_height[n], transform type[n], offsetX and offsetY as inputs, and the output is assigned to sample location (i, j).
      xProjPicture is set equal to projreg_left[n]+i.
      When StereoFlag is equal to 0 or TopBottomFlag is equal to 1, and when xProjPicture is greater than or equal to proj_picture_width, xProjPicture is set equal to xProjPicture−proj_picture_width.
      When SideBySideFlag is equal to 1, the following applies:
         When proj_reg_left[n] is less than proj_picture_width/2 and xProjPicture is greater than or equal to proj_picture_width/2, xProjPicture is set equal to xProjPicture−proj_picture_width/2.
         When proj_reg_left[n] is greater than or equal to proj_picture_width/2 and xProjPicture is greater than or equal to proj_picture_width, xProjPicture is set equal to xProjPicture−proj_picture_width/2.
      yProjPicture is set equal to proj_reg_top[n]+j.
   Clause 7.2.1.3 [of Choi] is invoked with xProjPicture, yProjPicture, MonoPicWidth, and MonoPicHeight as inputs, and the outputs indicating the sphere coordinates and the constituent frame index (for frame-packed stereoscopic video) for the luma sample location (xPackedPicture, yPackedPicture) belonging to the n-th packed region in the decoded picture.
      Otherwise, the following applies for each sample location (x, y) within the decoded picture:
xProjPicture is set equal to x+offsetX.
yProjPicture is set equal to y+offsetY.
Clause 7.2.1.3 [of Choi] is invoked with xProjPicture, yProjPicture, MonoPicWidth, and MonoPicHeight as inputs, and the outputs indicating the sphere coordinates and the constituent frame index (for frame-packed stereoscopic video) for the sample location (x, y) within the decoded picture.

With respect to conversion from a sample location in a projected picture to sphere coordinates relative to the global coordinate axes, Choi provides the following in Clause 7.2.1.3:

Inputs to this clause are
the center point of a sample location (xProjPicture, yProjPicture) within a projected picture, and
pictureWidth and pictureHeight, which are the width and height, respectively, of a monoscopic projected luma picture, in luma samples.
   NOTE: For stereoscopic video, this projected picture is top-bottom or side-by-side frame-packed.
   Outputs of this clause are:
   sphere coordinates (azimuthGlobal, elevationGlobal), in units of degrees relative to the global coordinate axes, and

when StereoFlag is equal to 1, the index of the constituent picture (constituentPicture) equal to 0 or 1.

The outputs are derived with the following ordered steps:
If xProjPicture is greater than or equal to pictureWidth or yProjPicture is greater than or equal to pictureHeight, the following applies:
   constituentPicture is set equal to 1.
   If xProjPicture is greater than or equal to pictureWidth, xProjPicture is set to xProjPicture−pictureWidth.
   If yProjPicture is greater than or equal to pictureHeight, yProjPicture is set to yProjPicture−pictureHeight.
Otherwise, constituentPicture is set equal to 0.
Depending on the projection format, the following applies:
   When the projection format is the equirectangular projection, clause 5.2.1 [of Choi] is invoked with pictureWidth, pictureHeight, xProjPicture, and yProjPicture as inputs, and the output is assigned to azimuthLocal, elevationLocal.
   When the projection format is the cubemap projection, clause 5.2.2 [of Choi] is invoked with pictureWidth, pictureHeight, xProjPicture, and yProjPicture as inputs, and the output is assigned to azimuthLocal, elevantionLocal.
If RotationFlag is equal to 1, clause 5.3 is invoked with azimuthLocal, elevantionLocal, rotation yaw÷2¹⁶, rotation_pitch÷2¹⁶, and rotation roll÷2¹⁶ as inputs, and the output is assigned to azimuthGlobal and elevationGlobal.
Otherwise, azimuthGlobal is set equal to azimuthLocal and elevationGlobal is set equal to elevationLocal.

As described above, Choi specifies a technique for how to store omnidirectional media and the associated metadata using the ISOBMFF and how to encapsulate, signal, and stream omnidirectional media using dynamic adaptive streaming over HTTP DASH. In particular, Choi specifies a region-wise packing structure (RegionWisePackingStruct) that specifies the mapping between packed regions and the respective projected regions and specifies the location and size of the guard bands, if any. The size of the projected picture is explicitly signalled in RegionWisePackingStruct.

With respect to RegionWisePackingStruct, Choi provides the following definition, syntax and semantics:

Definition

RegionWisePackingStruct specifies the mapping between packed regions and the respective projected regions and specifies the location and size of the guard bands, if any. The size of the projected picture is explicitly signalled in this structure.

NOTE 1: Among other information the RegionWisePackingStruct also provides the content coverage information in the 2D Cartesian picture domain.

Syntax

```
aligned(8) class RegionWisePackingStruct {
  unsigned int(1) constituent_picture_matching_regions;
  bit(7) reserved = 0;
  unsigned int(8) num_regions;
  unsigned int(16) proj_picture_width;
  unsigned int(16) proj_picture_height;
  unsigned int(16) packed_picture_width;
  unsigned int(16) packed_picture_height;
  for (i = 0; i < num_regions; i++) {
    bit(3) reserved = 0;
    unsigned int(1) guard_band_flag[i];
    unsigned int(4) packing_type[i];
    if (packing_type[i] == 0 {
        RectRegionPacking(i);
        if (guard_band_flag[i]) {
        unsigned int(8) left_gb_width[i];
        unsigned int(8) right_gb_width[i];
        unsigned int(8) top_gb_height[i];
        unsigned int(8) bottom_gb_height[i];
        unsigned int(1) gb_not_used_for_pred_flag[i];
        for (j = 0; j < 4; j++)
          unsigned int(3) gb_type[i]+j+;
        bit(3) reserved = 0;
        }
      }
    }
  }
  aligned(8) class RectRegionPacking(i) {
    unsigned int(16) proj_reg_width[i];
    unsigned int(16) proj_reg_height[i];
    unsigned int(16) proj_reg_top[i];
    unsigned int(16) proj_reg_left[i];
    unsigned int(3) transform_type[i];
    bit(5) reserved = 0;
    unsigned int(16) packed_reg_width[i];
    unsigned int(16) packed_reg_height[i];
    unsigned int(16) packed_reg_top[i];
    unsigned int(16) packed_reg_left[i];
}
```

Semantics

constituent_picture_matching_regions equal to 1 specifies that the projected region information, packed region information, and guard band region information in this box apply individually to each constituent picture and that the packed picture and the projected picture have the same stereoscopic frame packing format indicated by the StereoVideoBox. constituent_picture_matching_regions equal to 0 specifies that the projected region information, packed region information, and guard band region information in this box apply to the projected picture. When StereoFlag is equal to 0, constituent_picture_matching_regions shall be equal to 0.
NOTE 1: For the stereoscopic content that uses equivalent region-wise packing for the constituent pictures, setting this flag equal to 1 allows more compact signalling of region-wise packing information.
num_regions specifies the number of packed regions for which the projected region information, packed region information, and guard band region information are indicated. Value 0 is reserved. When constituent_picture_matching_regions is equal to 1, the total number of packed regions is equal to 2*num_regions and the information in RectRegionPacking(i) and in guard_band_flag[i], packing_type[i], left_gb_width[i], right_gb_width[i], top_gb_height[i], bottom_gb_height[i],
gb_not_used_for_pred_flag[i], and gb_type[i] applies to each constituent picture of the projected picture and the packed picture.
proj_picture_width and proj_picture_height specify the width and height, respectively, of the projected picture, in relative projected picture sample units. proj_picture_width and proj_picture_height shall both be greater than 0.
NOTE 2: The same sampling grid, width, and height are used for the luma sample array and the chroma sample arrays of the projected picture.
packed_picture_width and packed_picture_height specify the width and height, respectively, of the packed picture, in relative packed picture sample units. packed_picture_width and packed_picture_height shall both be greater than 0. packed_picture_width and packed_picture_height shall have such values that packed_reg_width[i], packed_reg_height[i], packed_reg_top[i], and
packed_reg_left[i], represent integer horizontal and vertical coordinates of luma sample units within the decoded pictures or the composition pictures, when RegionWisePackingBox is contained in ProjectedOmniVideoBox or SubPictureCompositionBox, respectively.
guard_band_flag[i] equal to 0 specifies that the i-th packed region does not have a guard band. guard band_flag[i] equal to 1 specifies that the i-th packed region has a guard band.
packing_type[i] specifies the type of region-wise packing. packing_type[i] equal to 0 indicates rectangular region-wise packing. Other values are reserved.
left_gb_width[i] specifies the width of the guard band on the left side of the i-th packed region in relative packed picture sample units. When the decoded picture has 4:2:0 or 4:2:2 chroma format, left_gb_width[i] shall correspond to an even number of luma samples within the decoded picture or the composition picture, when RegionWisePackingBox is contained in ProjectedOmniVideoBox or SubPictureCompositionBox [as specified in Choi], respectively.
right_gb_width[i] specifies the width of the guard band on the right side of the i-th packed region in relative packed picture sample units. When the decoded picture has 4:2:0 or 4:2:2 chroma format, right_gb_width[i] shall correspond to an even number of luma samples within the decoded picture or the composition picture, when RegionWisePackingBox is contained in ProjectedOmniVideoBox or SubPictureCompositionBox, respectively.
top_gb_height[i] specifies the height of the guard band above the i-th packed region in relative packed picture sample units. When the decoded picture has 4:2:0 chroma format, top_gb_height[i] shall correspond to an even number of luma samples within the decoded picture or the composition picture, when RegionWisePackingBox is contained in ProjectedOmniVideoBox or SubPictureCompositionBox, respectively. bottom_gb_height[i] specifies the height of the guard band below the i-th packed region in relative packed picture sample units. When the decoded picture has 4:2:0 chroma format, bottom_gb_height[i] shall correspond to an even number of luma samples within the decoded picture or the composition picture, when RegionWisePackingBox is contained in ProjectedOmniVideoBox or SubPictureCompositionBox, respectively.
When guard_band_flag[i] is equal to 1, left_gb_width[i], right_gb_width[i], top_gb_height[i], or bottom_gb_height[i] shall be greater than 0.
The i-th packed region as specified by this RegionWisePackingStruct shall not overlap with any other packed region specified by the same RegionWisePackingStruct or any guard band specified by the same RegionWisePackingStruct.
The guard bands associated with the i-th packed region, if any, as specified by this RegionWisePackingStruct shall not overlap with any packed region specified by the same RegionWisePackingStruct or any other guard bands specified by the same RegionWisePackingStruct.
gb_not_used_for_pred_flag[i] equal to 0 specifies that the guard bands may or may not be used in the inter prediction process. gb_not_used_for_pred_flag[i] equal to 1 specifies that the sample values of the guard bands are not in the inter prediction process.
NOTE 3: When gb_not_used_for_pred_flag[i] is equal to 1, the sample values within guard bands in decoded pictures can be rewritten even if the decoded pictures were used as references for inter prediction of subsequent pictures to be decoded. For example, the content of a packed region can be seamlessly expanded to its guard band with decoded and re-projected samples of another packed region.
gb_type[i][j] specifies the type of the guard bands for the i-th packed region as follows, with j equal to 0, 1, 2, and 3 indicating that the semantics below apply to the left, right, top, and bottom edge, respectively, of the packed region:
gb_type[i][j] equal to 0 specifies that the content of the guard bands in relation to the content of the packed regions is unspecified. gb_type[i][j] shall not be equal to 0, when gb_not_used_for_pred_flag [i] is equal to 0.
gb_type[i][j] equal to 1 specifies that the content of the guard bands suffices for interpolation of sub-pixel values within the packed region and less than one pixel outside of the boundary of the packed region.
   NOTE 4: gb_type[i][j] equal to 1 can be used when the boundary samples of a packed region have been copied horizontally or vertically to the guard band.
gb_type[i][j] equal to 2 specifies that the content of the guard bands represents actual image content at quality that gradually changes from the picture quality of the packed region to that of the spherically adjacent packed region.
gb_type[i][j] equal to 3 specifies that the content of the guard bands represents actual image content at the picture quality of the packed region.
gb_type[i][j] values greater than 3 are reserved.
   proj_reg_width[i], proj_reg_height[i], proj_reg_top[i] and proj_reg_left[i] are indicated in relative projected picture sample units.
   proj_reg_width[i] specifies the width of the i-th projected region.
   proj_reg_height[i] specifies the height of the i-th projected region.
   proj_reg_top[i] and proj_reg_left[i] specify the top sample row and the left-most sample column, respectively, of the i-th projected region, either in the projected picture (when constituent_picture_matching_regions is equal to 0) or in the constituent picture of the projected picture (when constituent_picture_matching_regions is equal to 1).
   The values of proj_reg_width[i], proj_reg_height[i], proj_reg_top[i], and proj_reg_left[i] are constrained as follows:
If StereoVideoFlag is equal to 0 or TopBottomFlag is equal to 1, proj_reg_width[i] shall be in the range of 1 to proj_picture_width, inclusive.
Otherwise (SideBySideFlag is equal to 1), proj_reg_width[i] shall be in the range of 1 to proj_picture_width/2, inclusive.
proj_reg_height[i] shall be greater than 0.
When constituent_picture_matching_regions is equal to 0, the values of proj_reg_top[i] and proj_reg_left[i] shall be in the range from 0, inclusive, indicating the top-left corner of the projected picture, to proj_picture_height−1, inclusive, and proj_picture_width−1, inclusive, respectively. When constituent_picture_matching_regions is equal to 1, the values of proj_reg_top[i] and proj_reg_left[i] shall be in the range from 0, inclusive, to proj_picture_height/VerDiv1−1, inclusive, and proj_picture_width/HorDiv1−1, inclusive, respectively.
When StereoVideoFlag is equal to 0 or constituent_picture_matching_regions is equal to 0, proj_reg_height[i] and proj_reg_top[i] shall be constrained such that proj_reg_height[i]+proj_reg_top[i]−1 is less than proj_picture_height.
When StereoVideoFlag is equal to 1, the following applies:
   proj_reg_width[i] shall be less than or equal to proj_picture_width/HorDiv1.
   proj_reg_height[i] shall be less than or equal to proj_picture_height/VerDiv1.
   If proj_reg_left[i] is less than proj_picture_width/HorDiv1, proj_reg_width[i] and proj_reg_left[i] shall be constrained such that proj_reg_width[i]+proj_reg_left[i]−1 is less than proj_picture_width/HorDiv1.
   Otherwise (proj_reg_left[i] is greater than or equal to proj_picture_width/HorDiv1), projreg_width[i] and proj_reg_left[i] shall be constrained such that proj_reg_width[i]+proj_reg_left[i]−proj_picture_width/HorDiv1−1 is less than proj_picture_width/HorDiv1.
   If proj_reg_top[i] is less than proj_picture_height/VerDiv1 then proj_reg_height[i] and proj_reg_top[i] shall be constrained such that proj_reg_height[i]+proj_reg_top[i]−1 is less than proj_picture_height/VerDiv1.
   Otherwise (i.e. when proj_reg_top[i] is greater than or equal to proj_picture_height/VerDiv1) then proj_regheight[i] and projreg_top[i] shall be constrained such that proj_reg_height[i]+proj_reg_top[i]−proj_picture_height/VerDiv1−1 is less than proj_picture_height/VerDiv1.
When constituent_picture_matching_regions is equal to 1, the following applies:
   proj_reg_width[i] and projreg_left[i] shall be constrained such that proj_reg_width[i]+proj_reg_left[i]−1 is less than proj_picture_width/HorDiv1.
   proj_reg_height[i] and proj_reg_top[i] shall be constrained such that proj_reg_height[i]+proj_reg_top[i]−1 is less than proj_picture_height/VerDiv1.
      transform_type[i] specifies the rotation and mirroring that is applied to the i-th packed region to remap it to the i-th projected region. When transform_type[i] specifies both rotation and mirroring, rotation is applied before mirroring for converting sample locations of a packed region to sample locations of a projected region. The following values are specified:
      0: no transform
      1: mirroring horizontally
      2: rotation by 180 degrees (counter-clockwise)
      3: rotation by 180 degrees (counter-clockwise) before mirroring horizontally
      4: rotation by 90 degrees (counter-clockwise) before mirroring horizontally
      5: rotation by 90 degrees (counter-clockwise)
      6: rotation by 270 degrees (counter-clockwise) before mirroring horizontally
      7: rotation by 270 degrees (counter-clockwise)
      NOTE 5: Clause 5.4 [of Choi] specifies the semantics of transform_type[i] for converting a sample location of a packed region in a packed picture to a sample location of a projected region in a projected picture.
      packed_reg_width[i], packed_reg_height[i], packed_reg_top[i], and packed_reg_left[i] specify the width, height, the top sample row, and the left-most sample column, respectively, of the i-th packed region, either within the packed picture (when constituent_picture_matching_regions is equal to 0) or within each constituent picture of the packed picture (when constituent_picture_matching_regions is equal to 1). packed_reg_width[i], packed_reg_height[i], packed_reg_top[i], and packed_reg_left[i] are indicated in relative packed picture sample units.
      The values of packed_reg_width[i], packed_reg_height[i], packed_reg_top[i], and packed_reg_left[i] are constrained as follows:
packed_reg_width[i] and packed_reg_height[i] shall be greater than 0.
packed_reg_top[i] and packed_reg_left[i] shall in the range from 0, inclusive, indicating the top-left corner of the packed picture, to packed_picture_height−1, inclusive, and packed_picture_width−1, inclusive, respectively.
If constituent_picture_matching_regions is equal to 0, the following applies:
   The sum of packed_reg_width[i] and packed_reg_left[i] minus 1 shall be less than packed_picture_width.
   The sum of packed_reg_height[i] and packed_reg_top[i] minus 1 shall be less than packed_picture_height.
Otherwise (constituent_picture_matching_regions is equal to 1), the following applies:
   The sum of packed_reg_width[i] and packed_reg_left[i] minus 1 shall be less than packed_picture_width/HorDiv1.
   The sum of packed_reg_height[i] and packed_reg_top[i] minus 1 shall be less than packed_picture_height/VerDiv1.
When the decoded picture has 4:2:0 or 4:2:2 chroma format, packed_reg_left[i] shall correspond to an even horizontal coordinate value of luma sample units within the decoded picture or the composition picture, when RegionWisePackingBox is contained in ProjectedOmniVideoBox or SubPictureCompositionBox, respectively.
When the decoded picture has 4:2:0 or 4:2:2 chroma format, and packed_reg_width[i] shall correspond to an even number of luma samples within the decoded picture or the composition picture, when RegionWisePackingBox is contained in ProjectedOmniVideoBox or SubPictureCompositionBox, respectively.
When the decoded picture has 4:2:0 chroma format, packed_reg_top[i] shall correspond to an even vertical coordinate value of luma sample units within the decoded picture or the composition picture, when RegionWisePackingBox is contained in ProjectedOmniVideoBox or SubPictureCompositionBox, respectively.
When the decoded picture has 4:2:0 chroma format, packed_reg_height[i] shall correspond to an even number of luma samples within the decoded picture or the composition picture, when RegionWisePackingBox is contained in ProjectedOmniVideoBox or SubPictureCompositionBox, respectively.

Further Choi provides the following definition and syntax for a projected omnidirectional video box in Clause 7.3.2:

Definition

Box Type: ‘povd’

Container: Scheme Information box (‘schi’)
Mandatory: Yes, when scheme_type is equal to ‘podv’

### Quantity: Zero or one

The properties of the projected pictures are indicated with the following:
the projection format of the projected picture (C for monoscopic video contained in the track, C_{L} and C_{R} for left and right view of stereoscopic video),
the rotation for conversion between the local cooridnate axes and the global coordinate axes, and
the spherical coverage of the projected omnidirectional video.

The values of the variables HorDiv1 and VerDiv1 are set as follows:
If StereoVideoBox is not present in ProjectedOmniVideoBox, HorDiv1 is set equal to 1 and VerDiv1 is set equal to 1.
Otherwise (StereoVideoBox is present in ProjectedOmniVideoBox), the following applies:
   If side-by-side frame packing is indicated, HorDiv1 is set equal to 2 and VerDiv1 is set equal to 1.
   Otherwise (top-bottom frame packing is indicated), HorDiv1 is set equal to 1 and VerDiv1 is set equal to 2.
      If RotationBox is not present in ProjectedOmniVideoBox, RotationFlag is set equal to 0. Otherwise, RotationFlag is set equal to 1.

If StereoVideoBox is not present in ProjectedOmniVideoBox, StereoFlag, TopBottomFlag, and SideBySideFlag are set equal to 0. Otherwise, the following applies:
StereoFlag is set equal to 1.
When the StereoVideoBox indicates top-bottom frame packing, TopBottomFlag is set equal to 1 and SideBySideFlag is set equal to 0.
When the StereoVideoBox indicates side-by-side frame packing, TopBottomFlag is set equal to 0 and SideBySideFlag is set equal to 1.
   When SubPictureCompositionBox is not present in the track, the following applies:
The width and height of a monoscopic projected luma picture (MonoPicWidth and MonoPicHeight, respectively) are derived as follows:
   If RegionWisePackingBox is not present in ProjectedOmniVideoBox, MonoPicWidth and MonoPicHeight are set to be equal to width/HorDiv1 and height/VerDiv1, respectively, where width and height are syntax elements of VisualSampleEntry.
   Otherwise, MonoPicWidth and MonoPicHeight are set equal to proj_picture_width/HorDiv1 and proj_picture_height/VerDiv1, respectively.
If RegionWisePackingBox is not present in ProjectedOmniVideoBox, RegionWisePackingFlag is set equal to 0. Otherwise, RegionWisePackingFlag is set equal to 1.
The semantics of the sample locations of each decoded picture resulting by decoding the samples referring to this sample entry are specified in [Clause 7.2.1.2 of Choi]. NOTE: When SubPictureCompositionBox is present in the track, the derivation of MonoPicWidth, MonoPicHeight, and RegionWisePackingFlag is specified in [Clause 7.4.1 of Choi] and clause 7.2.1.2 [of Choi] specifies the semantics of the sample locations of a composition picture corresponding to the SubPictureCompositionBox.

Syntax

```
aligned(8) class ProjectedOmniVideoBox extends Box(‘povd’) {
  ProjectionFormatBox( ); // mandatory
  // optional boxes but no fields
}
aligned(8) class ProjectionFormatBox( ) extends FullBox(‘prfr’, 0, 0) {
  ProjectionFormatStruct( );
}
```

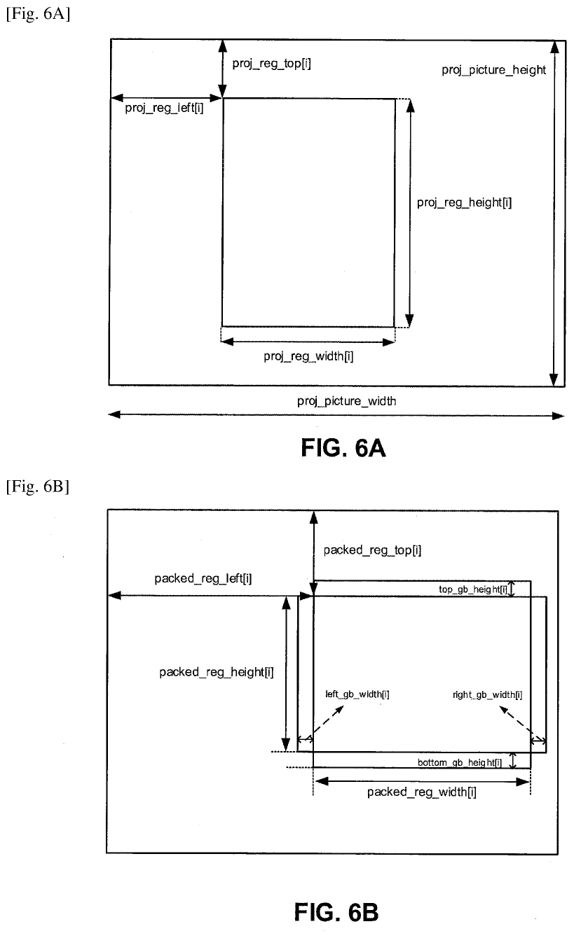

As provided above with respect to RegionWisePackingStruct, dimensions, including guard bands are specified for projected and packed pictures. FIG. 6A illustrates the position and size of a projected region within a projected picture and FIG. 6B illustrates that of a packed region within a packed picture with guard bands.

Referring again to FIG. 2A, as illustrated in the example of FIG. 2A, each slice of video data included in the group pictures is associated with a network abstraction layer unit. In ITU-T H.265, a coded video sequence may be encapsulated (or structured) as a sequence of access units, where each access unit includes video data structured as network abstraction layer (NAL) units. In ITU-T H.265, access units and NAL units are defined as:

network abstraction layer (NAL) unit: A syntax structure containing an indication of the type of data to follow and bytes containing that data in the form of an raw byte sequence payload (RBSP) interspersed as necessary with emulation prevention bytes.

access unit: A set of NAL units that are associated with each other according to a specified classification rule, are consecutive in decoding order, and contain exactly one coded picture with nuh_layer_id equal to 0.

In ITU-T H.265 each of a video sequence, a GOP, a picture, a slice, and CTU may be associated with metadata that describes video coding properties. ITU-T H.265 defines parameters sets that may be used to describe video data and/or video coding properties. In ITU-T H.265, parameter sets may be encapsulated as a special type of NAL unit or may be signaled as a message. NAL units including coded video data (e.g., a slice) may be referred to as VCL (Video Coding Layer) NAL units and NAL units including metadata (e.g., parameter sets) may be referred to as non-VCL NAL units. ITU-T H.265 provides the following types of defined parameter sets:

video parameter set (VPS): A syntax structure containing syntax elements that apply to zero or more entire coded video sequences (CVSs) as determined by the content of a syntax element found in the SPS referred to by a syntax element found in the PPS referred to by a syntax element found in each slice segment header.
sequence parameter set (SPS): A syntax structure containing syntax elements that apply to zero or more entire CVSs as determined by the content of a syntax element found in the PPS referred to by a syntax element found in each slice segment header. picture parameter set (PPS): A syntax structure containing syntax elements that apply to zero or more entire coded pictures as determined by a syntax element found in each slice segment header.

Further, ITU-T H.265 enables video usability information (VUI) and supplemental enhancement information (SEI) messages to be signaled. In ITU-T H.265, SEI messages assist in processes related to decoding, display or other purposes. However, SEI messages may not be required for constructing the luma or chroma samples by the decoding process. In ITU-T H.265, SEI messages may be signaled in a bitstream using non-VCL NAL units. Further, SEI messages may be conveyed by mechanisms other than by being present in the bitstream (i.e., signaled out-of-band).

As described above, ITU-T H.265 enables supplemental enhancement information (SEI) messages to be signaled. JCTVC-AB 1005, “HEVC Additional Supplemental Enhancement Information (Draft 3),” Boyce et al. submitted to the Joint Collaborative Team on Video Coding (JCT-VC) of ITU-T SG16 WP3 and ISO/IEC JTC1/SC29/WG11 28th Meeting: Torino IT, 15-21 Jul. 2017 (hereinafter Boyce) describes changes to the ITU-T H.265 to specify additional SEI messages including an SEI message for region-wise packing. Table 1 provides the syntax of a region-wise packing SEI message specified in Boyce. It should be noted that in Table 1 and other tables herein, a descriptor u(n) refers to an unsigned integer using n-bits.

TABLE 1

| | |
|---|---|
| regionwise_packing(payloadSize ) { | Descriptor |
| rwp_cancel_flag | u(1) |
| if( !rwp_cancel_flag ) { | |
| rwp_persistence_flag | u(1) |
| rwp_reserved_zero_6bits | u(6) |
| num_packed_regions | u(8) |
| proj_picture_width | u(16) |
| proj_picture_height | u(16) |
| for( i = 0; i < num_packed_regions; i++) { | |
| rwp_reserved_zero_4bits[i] | u(4) |
| packing_type[i] | u(4) |
| if( packing_type[i] == 0) { | |
| proj_region_width[i] | u(16) |
| proj_region_height[i] | u(16) |
| proj_region_top[i] | u(16) |
| proj_region_left[i] | u(16) |
| transform_type[i] | u(3) |
| rwp_reserved_zero_5bits[i] | u(5) |
| packed_region_width[i] | u(16) |
| packed_region_height[i] | u(16) |
| packed_region_top[i] | u(16) |
| packed_region_left[i] | u(16) |
| } | |
| } | |
| } | |
| } | |

With respect to Table 1, Boyce provides the following Region-wise packing SEI message semantics:

The region-wise packing SEI message provides information to enable remapping of the colour samples of the cropped output pictures onto projected pictures.

rwp_cancel_flag equal to 1 indicates that the SEI message cancels the persistence of any previous region-wise packing SEI message in output order. rwp_cancel_flag equal to 0 indicates that region-wise packing information follows.

rwp_persistence_flag specifies the persistence of the region-wise packing SEI message for the current layer.
rwp_persistence_flag equal to 0 specifies that the region-wise packing SEI message applies to the current decoded picture only.

Let picA be the current picture. rwp_persistence_flag equal to 1 specifies that the region-wise packing SEI message persists for the current layer in output order until one or more of the following conditions are true:
A new CLVS of the current layer begins.
The bitstream ends.
A picture picB in the current layer in an access unit containing a region-wise packing SEI message that is applicable to the current layer is output for which PicOrderCnt(picB) is greater than PicOrderCnt(picA), where PicOrderCnt(picB) and PicOrderCnt(picA) are the PicOrderCntVal values of picB and picA, respectively, immediately after the invocation of the decoding process for picture order count for picB. When an equirectangular projection SEI message with erp_cancel_flag equal to 0 or a cubemap projection SEI message with cmp_cancel_flag equal to 0 is not present in the CLVS that applies to the current picture and precedes the region-wise packing SEI message in decoding order, a region-wise packing SEI message with rwp_persistence_flag equal to 0 shall not be present in the CLVS that applies to the current picture. Decoders shall ignore region-wise packing SEI messages with rwp_persistence_flag equal to 0 that do not follow, in decoding order, an equirectangular projection SEI message with erp_cancel_flag equal to 0 or a cubemap projection SEI message with cmp_cancel_flag equal to 0 in the CLVS that applies to the current picture.
   rwp_reserved_zero_6bits shall be equal to 0 in bitstreams conforming to this version of this Specification. Other values for rwp_reserved_zero_6bits[i] are reserved for future use by ITU-T|ISO/IEC. Decoders shall ignore the value of rwp_reserved_zero_6bits[i].
   num_packed_regions specifies the number of packed regions. The value of
   num_packed_regions shall be greater than 0.
   proj_picture_width and proj_picture_height specify the width and height, respectively, of the projected picture. The value of proj_picture_width and proj_picture_height shall be both greater than 0.
   rwp_reserved_zero_4bits shall be equal to 0 in bitstreams conforming to this version of this Specification. Other values for rwp_reserved_zero_4bits[i] are reserved for future use by ITU-T|ISO/IEC. Decoders shall ignore the value of rwp_reserved_zero_4bits[i].
   packing_type[i] specifies the type of region-wise packing. packing_type[i] equal to 0 indicates rectangular region-wise packing. Other values are reserved. The value of packing_type[i] shall be equal to 0 in this version of this Specification. Decoders shall allow values of packing_type[i] greater than 0 and shall ignore all region-wise packing SEI messages with packing_type[i] greater than 0 for any value of i.
   proj_region_width[i], proj_region_height[i], proj_region_top[i], and
   proj_region_left[i] are indicated in units of luma samples in a projected picture with width and height equal to proj_picture_width and proj_picture_height, respectively.
   proj_region_width[i] specifies the width of the i-th projected region.
   proj_region_width[i] shall be greater than 0.
   proj_region_height[i] specifies the height of the i-th projected region.
   proj_region_height[i] shall be greater than 0.
   proj_region_top[i] and proj_region_left[i] specify the top luma sample row and the left-most luma sample column, respectively, in the projected picture. The values of
   proj_region_top[i] and proj_region_left[i], shall be in the range from 0, inclusive, indicating the top-left corner of the projected picture, to proj_picture_height−1, inclusive, and proj_picture_width−1, inclusive, respectively.
   The sum of proj_region_width[i] and proj_region_left[i] shall be less than proj_picture_width. The sum of proj_region_height[i] and proj_region_top[i] shall be less than proj_picture_height.
   The values of proj_region_width[i], proj_region_height[i], proj_region_top[i] and proj_region_left[i] shall be such that the projected region identified by these fields is within a single constituent picture of the projected picture.
   NOTE—Two projected regions may partially or entirely overlap with each other. transform_type[i] specifies the rotation and mirroring to be applied to the i-th packed region to remap to the i-th projected region. When transform_type[i] specifies both rotation and mirroring, rotation applies before mirroring. The values of transform_type[i] are specified in Table D.X:

TABLE D.X
transform_type[i] values

| Value | Description |
|---|---|
| 0 | no transform |
| 1 | mirroring horizontally |
| 2 | rotation by 180 degrees (counter-clockwise) |
| 3 | rotation by 180 degrees (counter-clockwise) after mirroring |
| | horizontally |
| 4 | rotation by 90 degrees (counter-clockwise) before mirroring |
| | horizontally |
| 5 | rotation by 90 degrees (counter-clockwise) |
| 6 | rotation by 270 degrees (counter-clockwise) before |
| | mirroring horizontally |
| 7 | rotation by 270 degrees (counter-clockwise) |

rwp_reserved_zero_5bits shall be equal to 0 in bitstreams conforming to this version of this Specification. Other values for rwp_reserved_zero_5bits[i] are reserved for future use by ITU-T|ISO/IEC. Decoders shall ignore the value of rwp_reserved_zero_5bits[i].
packed_region_width[i], packed_region_height[i], packed_region_top[i], and packed_region_left[i] specify the width, height, the top luma sample row, and the left-most luma sample column, respectively, of the packed region in the region-wise packed picture.
Let packedPicWidth and packedPicHeight be the width and height of the conformance cropping window of the region-wise packed picture. The values of packed_region_width[i], packed_region_height[i], packed_region_top[i], and packed_region_left[i] are constrained as follows:
packed_region_width[i] and packed_region_height[i] shall both be greater than 0.
The values of packed region_top[i] and packed_region_left[i] shall be in the range from 0, inclusive, indicating the top-left corner luma sample of the region-wise packed picture, to packedPicHeight−1, inclusive, and packedPicWidth−1, inclusive, respectively.
The sum of packed_region_width[i] and packed_region_left[i] shall be less than packedPicWidth.
The sum of packed_region_height[i] and packed_region_top[i] shall be less than packedPicHeight.
The rectangle specified by packed_region_width[i], packed_region_height[i], packed_region_top[i], and packed_region_left[i] shall be non-overlapping with the rectangle specified by packed_region_width[j], packed_region_height[j], packed_region_top[j], and packed_region_left[j] for any value of j in the range of 0 to i−1, inclusive.

It should be noted that Boyce provides the following with respect to a sample location mapping process:

To remap colour sample locations of a region-wise packed picture to a unit sphere, the following ordered steps are applied:
A region-wise packed picture is obtained as the cropped output picture by decoding a coded picture. For purposes of interpretation of chroma samples, the input to the indicated remapping process is the set of decoded sample values after applying an (unspecified) upsampling conversion process to the 4:4:4 colour sampling format as necessary when chroma_format_idc is equal to 1 (4:2:0 chroma format) or 2 (4:2:2 chroma format). This (unspecified) upsampling process should account for the relative positioning relationship between the luma and chroma samples as indicated by chroma_sample_loc_type_top_field and chroma_sample_loc_type_bottom_field, when present.
If region-wise packing is indicated, the sample locations of the region-wise packed picture are converted to sample locations of the respective projected picture as specified in clause D.3.41.5.4 [of Boyce]. Otherwise, the projected picture is identical to the region-wise packed picture.
If frame packing is indicated, the sample locations of the projected picture are converted to sample locations of the respective constituent picture of the projected picture, as specified in clause D.3.41.5.6 [of Boyce]. Otherwise, the constituent picture of the projected picture is identical to the projected picture.
The sample locations of a constituent picture the projected picture are converted to sphere coordinates relative to the local coordinate axes, as specified in clause D.3.41.5.2 [of Boyce]
If rotation is indicated, the sphere coordinates relative to the local coordinate axes are converted to sphere coordinates relative to the global coordinate axes, as specified in clause D.3.41.5.3 [of Boyce]. Otherwise, the global coordinate axes are identical to the local coordinate axes.

The overall process for mapping of luma sample locations within a region-wise packed picture to sphere coordinates relative to the global coordinate axes is normatively specified in clause D.3.41.5.5 [of Boyce].

For each region-wise packed picture corresponding to a decoded picture, the following applies:
If an equirectangular projection SEI message with erp_cancel_flag equal to 0 and erp_rotation_flag equal to 1 that applies to the picture is present, or a cubemap projection SEI message with cmp_cancel_flag equal to 0 and cmp_rotation_flag equal to 1 that applies to the picture is present, RotationFlag is set equal to 1, and the following applies.
If equirectangular projection is indicated, RotationYaw, RotationPitch, and RotationRoll are set equal to erp_yaw_rotation+2¹⁶, erp_pitch_rotation÷2¹⁶, and erp_roll_rotation÷2¹⁶, respectively.
Otherwise, RotationYaw, RotationPitch, and RotationRoll are set equal to cmp_yaw_rotation÷2¹⁶, cmp_pitch_rotation÷2¹⁶, and cmp_roll_rotation÷2¹⁶, respectively.
Otherwise, RotationFlag is set equal to 0.
If a frame packing arrangement SEI message with frame_packing_arrangement_cancel_flag equal to 0 that applies to the picture is not present, StereoFlag, TopBottomFlag, and SideBySideFlag are all set equal to 0, HorDiv1 is set equal to 1, and VerDiv1 is set equal to 1.
Otherwise, the following applies:
StereoFlag is set equal to 1.
If the value of frame_packing_arrangement_type of the frame packing arrangement SEI message is equal to 3, TopBottomFlag is set equal to 0, SideBySideFlag is set equal to 1, HorDiv1 is set equal to 2 and VerDiv1 is set equal to 1.
Otherwise, if the value of frame_packing_arrangement_type of the frame packing arrangement SEI message is equal to 4, TopBottomFlag is set equal to 1, SideBySideFlag is set equal to 0, HorDiv1 is set equal to 1, and VerDiv1 is set equal to 2.
Otherwise, TopBottomFlag is set equal to 0, SideBySideFlag is set equal to 0, HorDiv1 is set equal to 1, and VerDiv1 is set equal to 1.
If a region-wise packing SEI message with rwp_cancel_flag equal to 0 that applies to the picture is not present, RegionWisePackingFlag is set equal to 0, and ConstituentPicWidth and ConstituentPicHeight are set to be equal to cropPicWidth/HorDiv1 and cropPicHeight/VerDiv1, respectively, where cropPicWidth and cropPicHeight are the width and height, respectively, of the cropped output picture.
Otherwise, RegionWisePackingFlag is set equal to 1, and ConstituentPicWidth and ConstituentPicHeight are set equal to proj_picture_width/HorDiv1 and proj_picture_height/VerDiv1, respectively.

It should be noted that process described in D.3.41.5.2, D.3.41.5.3, D.3.41.5.4, and D.3.41.5.6 of Boyce referenced above are similar to corresponding processes in Choi and for the sake of brevity are not reproduced herein. However, it should be noted that D.3.41.5.5 of Boyce provides the following with respect to mapping of luma sample locations within a region-wise packed picture to sphere coordinates relative to the global coordinate axes:

D.3.41.5.5 Mapping of luma sample locations within a region-wise packed picture to sphere coordinates relative to the global coordinate axes
This clause specifies the semantics of luma sample locations within a region-wise packed picture to sphere coordinates relative to the global coordinate axes.
This clause uses variables HorDiv1, VerDiv1, RotationFlag, StereoFlag, TopBottomFlag, SideBySideFlag, ConstituentPicWidth, ConstituentPicHeight, and RegionWisePackingFlag that are derived specific to the type of the decoded picture for which the corresponding region-wise packed picture this clause is applied to.
offsetX is set equal to 0.5 and offsetY is set equal to 0.5.
If RegionWisePackingFlag is equal to 1, the following applies for each packed region n in the range of 0 to num_regions−1, inclusive:
For each sample location (xPackedPicture, yPackedPicture) belonging to the n-th packed region with packing_type[n] equal to 0 (i.e., with rectangular region-wise packing), the following applies:
The corresponding sample location (xProjPicture, yProjPicture) of the projected picture is derived as follows:
x is set equal to xPackedPicture-packed_region_left[n].
y is set equal to yPackedPicture-packed_region_top[n].
Clause D.3.41.5.4 [of Boyce] is invoked with x, y, packed_region_width[n], packed_region_height[n], proj_region_width[n], proj_region_height[n], transform_type[n], offsetX and offsetY as inputs, and the output is assigned to sample location (i, j).
xProjPicture is set equal to proj_region_left[n]+i.
When StereoFlag is equal to 0 or TopBottomFlag is equal to 1, and when xProjPicture is greater than or equal to proj_picture_width, xProjPicture is set equal to xProjPicture−proj_picture_width.
When SideBySideFlag is equal to 1, the following applies:
When proj_region_left[n] is less than proj_picture_width/2 and xProjPicture is greater than or equal to proj_picture_width/2, xProjPicture is set equal to xProjPicture−proj_picture_width/2.
When proj_region_left[n] is greater than or equal to proj_picture_width/2 and xProjPicture is greater than or equal to proj_picture_width, xProjPicture is set equal to xProjPicture−proj_picture_width/2.
yProjPicture is set equal to proj_region_top[n]+j.
Clause D3.41.5.6 [of Boyce] is invoked with xProjPicture, yProjPicture, ConstituentPicWidth, and ConstituentPicHeight as inputs, and the outputs indicating the sphere coordinates and the constituent picture index (for frame-packed stereoscopic video) for the luma sample location (xPackedPicture, yPackedPicture) belonging to the n-th packed region in the decoded picture.
   Otherwise, the following applies for each sample location (x, y) within the region-wise packed picture:
xProjPicture is set equal to x+offsetX.
yProjPicture is set equal to y+offsetY.
Clause D.3.41.5.6 [of Boyce] is invoked with xProjPicture, yProjPicture, ConstituentPicWidth, and ConstituentPicHeight as inputs, and the outputs indicating the sphere coordinates and the constituent picture index (for frame-packed stereoscopic video) for the sample location (x, y) within the region-wise packed picture.

Further, Table 2 provides that syntax for a frame packing arrangement type SEI Message provided in ITU-T H.265.

TABLE 2

| | |
|---|---|
| frame_packing_arrangement( payloadSize ) { | Descriptor |
| frame_packing_arrangement_id | ue(v) |
| frame_packing_arrangement_cancel_flag | u(1) |
| if( !frame_packing_arrangement_cancel_flag) { | |
| frame_packing_arrangement_type | u(7) |
| quincunx_samplingflag | u(1) |
| content_interpretation_type | u(6) |
| spatial_flipping_flag | u(1) |
| frame0_flipped_flag | u(1) |
| field_views_flag | u(1) |
| current_frame_is_frame0_flag | u(1) |
| frame0_self_contained_flag | u(1) |
| frame1_self_contained_flag | u(1) |
| if( !quineurix_sampling_flag && frame_packing_arrangement_type != 5) { | |
| frame0_grid_position_x | u(4) |
| frame0_grid_position_y | u(4) |
| frame1_grid_position_x | u(4) |
| frame1_grid_position_y | u(4) |
| } | |
| frame_packing_arrangement_reserved_byte | u(8) |
| frame_packing_arrangement_persistence_flag | u(1) |
| } | |
| upsampled_aspect_ratio_flag | u(1) |
| } | |

ITU-T H.265 provides the following semantics for a frame packing arrangement type SEI message:

This SEI message informs the decoder that the output cropped decoded picture contains samples of multiple distinct spatially packed constituent frames that are packed into one frame using an indicated frame packing arrangement scheme. This information can be used by the decoder to appropriately rearrange the samples and process the samples of the constituent frames appropriately for display or other purposes (which are outside the scope of this Specification).

This SEI message may be associated with pictures that are either frames (when field_seq_flag is equal to 0) or fields (when field_seq_flag is equal to 1). The frame packing arrangement of the samples is specified in terms of the sampling structure of a frame in order to define a frame packing arrangement structure that is invariant with respect to whether a picture is a single field of such a packed frame or is a complete packed frame.

When general_non_packed_constraint_flag is equal to 1 for a CVS, there shall be no frame packing arrangement SEI messages in the CVS.
frame_packing_arrangement_id contains an identifying number that may be used to identify the usage of the frame packing arrangement SEI message. The value of frame_packing_arrangement_id shall be in the range of 0 to 2³²−2, inclusive.
Values of frame_packing_arrangement_id from 0 to 255 and from 512 to 2³¹−1 may be used as determined by the application. Values of frame_packing_arrangement_id from 256 to 511 and from 2³¹ to 2³²−2 are reserved for future use by ITU-T|ISO/IEC. Decoders shall ignore all frame packing arrangement SEI messages containing a value of frame_packing_arrangement_id in the range of 256 to 511, inclusive, or in the range of 2³¹ to 2³²−2, inclusive, and bitstreams shall not contain such values.
frame_packing_arrangement_cancel_flag equal to 1 indicates that the frame packing arrangement SEI message cancels the persistence of any previous frame packing arrangement SEI message in output order that applies to the current layer.
frame_packing_arrangement_cancel_flag equal to 0 indicates that frame packing arrangement information follows.
frame_packing_arrangement_type indicates the type of packing arrangement of the frames as specified in Table D.8.

TABLE D.8
Definition of frame_packing_arrangement_type

| Value | Interpretation |
|---|---|
| 3 | Each component plane of the decoded frames contains a side- |
| | by-side packing arrangement of corresponding planes of two |
| | constituent frames as illustrated in FIG. D.4, FIG. D.5, and |
| | FIG. D.8 [of ITU-T H.265] |
| 4 | Each component plane of the decoded frames contains a top- |
| | bottom packing arrangement of corresponding planes of two |
| | constituent frames as illustrated in FIG. D.6, and FIG. D.7 |
| | [of ITU-T H.265] |
| 5 | The component planes of the decoded frames in output |
| | order form a temporal interleaving of alternating first and |
| | second constituent frames as illustrated in FIG. D.9 |

quincunx_sampling_flag equal to 1 indicates that each colour component plane of each constituent frame is quincunx sampled as illustrated in Figure D.8 [of ITU-T H.265] and quincunx_sampling_flag equal to 0 indicates that the colour component planes of each constituent frame are not quincunx sampled.
When frame_packing_arrangement_type is equal to 5, it is a requirement of bitstream conformance that quincunx_sampling_flag shall be equal to 0.
NOTE 5—For any chroma format (4:2:0, 4:2:2 or 4:4:4), the luma plane and each chroma plane is quincunx sampled as illustrated in Figure D.8 [of ITU-T H.265] when quincunx_sampling_flag is equal to 1.
content_interpretation_type indicates the intended interpretation of the constituent frames as specified in Table D.9. Values of content_interpretation_type that do not appear in Table D.9 are reserved for future specification by ITU-T IISO/IEC and shall not be present in bitstreams conforming to this version of this Specification. Decoders shall ignore frame packing arrangement SEI messages that contain reserved values of content_interpretation_type.
For each specified frame packing arrangement scheme, there are two constituent frames that are referred to as frame 0 and frame 1.

TABLE D.9
Definition of content_interpretation_type

| Value | Interpretation |
|---|---|
| 0 | Unspecified relationship between the frame packed constituent |
| | frames |
| 1 | Indicates that the two constituent frames form the left and right |
| | views of a stereo view scene, with frame 0 being associated |
| | with the left view and frame 1 being associated with the right |
| | view |
| 2 | Indicates that the two constituent frames form the right and |
| | left views of a stereo view scene, with frame 0 being associated |
| | with the right view and frame 1 being associated with |
| | the left view |

spatial_flipping_flag equal to 1, when frame_packing_arrangement_type is equal to 3 or 4, indicates that one of the two constituent frames is spatially flipped relative to its intended orientation for display or other such purposes.
When frame_packing_arrangement_type is equal to 3 or 4 and spatial_flipping_flag is equal to 1, the type of spatial flipping that is indicated is as follows:
If frame_packing_arrangement_type is equal to 3, the indicated spatial flipping is horizontal flipping.
Otherwise (frame_packing_arrangement_type is equal to 4), the indicated spatial flipping is vertical flipping. When frame_packing_arrangement_type is not equal to 3 or 4, it is a requirement of bitstream conformance that spatial_flipping_flag shall be equal to 0. When frame_packing_arrangementtype is not equal to 3 or 4, the value 1 for spatial_flipping_flag is reserved for future use by ITU-T|ISO/IEC. When frame_packing_arrangement_type is not equal
   to 3 or 4, decoders shall ignore the value 1 for spatial_flipping_flag. frame0_flipped_flag, when spatial_flipping_flag is equal to 1, indicates which one of the two constituent frames is flipped.
   When spatial_flipping_flag is equal to 1, frame0_flipped_flag equal to 0 indicates that frame 0 is not spatially flipped and frame 1 is spatially flipped and frame0_flipped_flag equal to 1 indicates that frame 0 is spatially flipped and frame 1 is not spatially flipped.
   When spatial_flipping_flag is equal to 0, it is a requirement of bitstream conformance that frame0_flipped_flag shall be equal to 0. When spatial_flipping_flag is equal to 0, the value 1 for spatial_flipping_flag is reserved for future use by ITU-T|ISO/IEC. When spatial_flipping_flag is equal to 0, decoders shall ignore the value of frame0_flipped_flag.
   field_views_flag equal to 1 indicates that all pictures in the current CVS are coded as fields, all fields of a particular parity are considered a first constituent frame and all fields of the opposite parity are considered a second constituent frame. It is a requirement of bitstream conformance that the field_views_flag shall be equal to 0, the value 1 for field_views_flag is reserved for future use by ITU-T|ISO/IEC and decoders shall ignore the value of field_views_flag.
   current_frame_is_frame0_flag equal to 1, when frame_packing_arrangement is equal to 5, indicates that the current decoded frame is constituent frame 0 and the next decoded frame in output order is constituent frame 1 and the display time of the constituent frame 0 should be delayed to coincide with the display time of constituent frame 1. current_frame_is_frame0_flag equal to 0, when frame_packing_arrangement is equal to 5, indicates that the current decoded frame is constituent frame 1 and the previous decoded frame in output order is constituent frame 0 and the display time of the constituent frame 1 should not be delayed for purposes of stereo-view pairing. When frame_packing_arrangement_type is not equal to 5, the constituent frame associated with the upper-left sample of the decoded frame is considered to be constituent frame 0 and the other constituent frame is considered to be constituent frame 1. When frame_packing_arrangement_type is not equal to 5, it is a requirement of bitstream conformance that current_frame_is_frame0_flag shall be equal to 0. When frame_packing_arrangement_type is not equal to 5, the value 1 for current_frame_is_frame0_flag is reserved for future use by ITU-T|ISO/IEC. When frame_packing_arrangement_type is not equal to 5, decoders shall ignore the value of current_frame_is_frame0_flag.
   frame0_self_contained_flag equal to 1 indicates that no inter prediction operations within the decoding process for the samples of constituent frame 0 of the CVS refer to samples of any constituent frame 1. frame0_self_contained_flag equal to 0 indicates that some inter prediction operations within the decoding process for the samples of constituent frame 0 of the CVS may or may not refer to samples of some constituent frame 1. Within a CVS, the value of frame0_self_contained_flag in all frame packing arrangement SEI messages shall be the same.
   frame 1_self_contained_flag equal to 1 indicates that no inter prediction operations within the decoding process for the samples of constituent frame 1 of the CVS refer to samples of any constituent frame 0. frame 1_self_contained_flag equal to 0 indicates that some inter prediction operations within the decoding process for the samples of constituent frame 1 of the CVS may or may not refer to samples of some constituent frame 0. Within a CVS, the value of frame1_self_contained_flag in all frame packing arrangement SEI messages shall be the same.
   When quincunx_sampling_flag is equal to 0 and frame_packing_arrangement_type is not equal to 5, two (x, y) coordinate pairs are specified to determine the indicated luma sampling grid alignment for constituent frame 0 and constituent frame 1, relative to the upper left corner of the rectangular area represented by the samples of the corresponding constituent frame.
   frame0_grid_position_x (when present) specifies the x component of the (x, y) coordinate pair for constituent frame 0.
   frame0_grid_position_y (when present) specifies the y component of the (x, y) coordinate pair for constituent frame 0.
   frame1_grid_position_x (when present) specifies the x component of the (x, y) coordinate pair for constituent frame 1.
   frame1_grid_position_y (when present) specifies the y component of the (x, y) coordinate pair for constituent frame 1.
   When quincunx_sampling_flag is equal to 0 and frame_packing_arrangement_type is not equal to 5 the (x, y) coordinate pair for each constituent frame is interpreted as follows:
If the (x, y) coordinate pair for a constituent frame is equal to (0, 0), this indicates a default sampling grid alignment specified as follows:
If frame_packing_arrangement_type is equal to 3, the indicated position is the same as for the (x, y) coordinate pair value (4, 8), as illustrated in Figure D.4 [of ITU-T H.265].
Otherwise (frame_packing_arrangement_type is equal to 4), the indicated position is the same as for the (x, y) coordinate pair value (8, 4), as illustrated in Figure D.6 [of ITU-T H.265].
Otherwise, if the (x, y) coordinate pair for a constituent frame is equal to (15, 15), this indicates that the sampling grid alignment is unknown or unspecified or specified by other means not specified in this Specification.
Otherwise, the x and y elements of the (x, y) coordinate pair specify the indicated horizontal and vertical sampling grid alignment positioning to the right of and below the upper left corner of the rectangular area represented by the corresponding constituent frame, respectively, in units of one sixteenth of the luma sample grid spacing between the samples of the columns and rows of the constituent frame that are present in the decoded frame (prior to any upsampling for display or other purposes). frame_packing_arrangement_reserved_byte is reserved for future use by ITU-T|ISO/IEC. It is a requirement of bitstream conformance that the value of frame_packing_arrangement_reserved_byte shall be equal to 0. All other values of frame_packing_arrangement_reserved_byte are reserved for future use by ITU-T|ISO/IEC. Decoders shall ignore the value of frame_packing_arrangement_reserved_byte.
   frame_packing_arrangement_persistence_flag specifies the persistence of the frame packing arrangement SEI message for the current layer. frame_packing_arrangement_persistence_flag equal to 0 specifies that the frame packing arrangement SEI message applies to the current decoded frame only.
   Let picA be the current picture. frame_packing_arrangement_persistence_flag equal to 1 specifies that the frame packing arrangement SEI message persists for the current layer in output order until any of the following conditions are true:
A new CLVS of the current layer begins.
The bitstream ends.
A frame picB in the current layer in an access unit containing a frame packing arrangement SEI message with the same value of frame_packing_arrangement_id and applicable to the current layer is output for which PicOrderCnt(picB) is greater than PicOrderCnt(picA), where PicOrderCnt(picB) and PicOrderCnt(picA) are the PicOrderCntVal values of picB and picA, respectively, immediately after the invocation of the decoding process for picture order count for picB.
   upsampled_aspect_ratio_flag equal to 1 indicates that the sample aspect ratio (SAR) indicated by the VUI parameters of the SPS identifies the SAR of the samples after the application of an upconversion process to produce a higher resolution frame from each constituent frame as illustrated in Figure D.4 to Figure D.8 [of ITU-T H.265]. upsampled_aspect_ratio_flag equal to 0 indicates that the SAR indicated by the VUI parameters of the SPS identifies the SAR of the samples before the application of any such upconversion process.

The SEI message for region-wise packing specifed in Boyce may be less than ideal. For example, SEI message for region-wise packing specifed in Boyce fails to provide a way to handle all of the values of frame_packing_arrangement_type specified in ITU-T H.265 efficiently. For example, the SEI message for region-wise packing specifed in Boyce when used for stereo frame packed video may results in information about regions being signalled two times (once for the left view and once for the right view) when similar region structure is used for both the views. Such type of signaling is wasteful of bits. Further, it should be noted that the process for mapping of luma sample locations within a region-wise packed picture to sphere coordinates relative to the global coordinate axes, described in Choi and Boyce may be less than ideal.

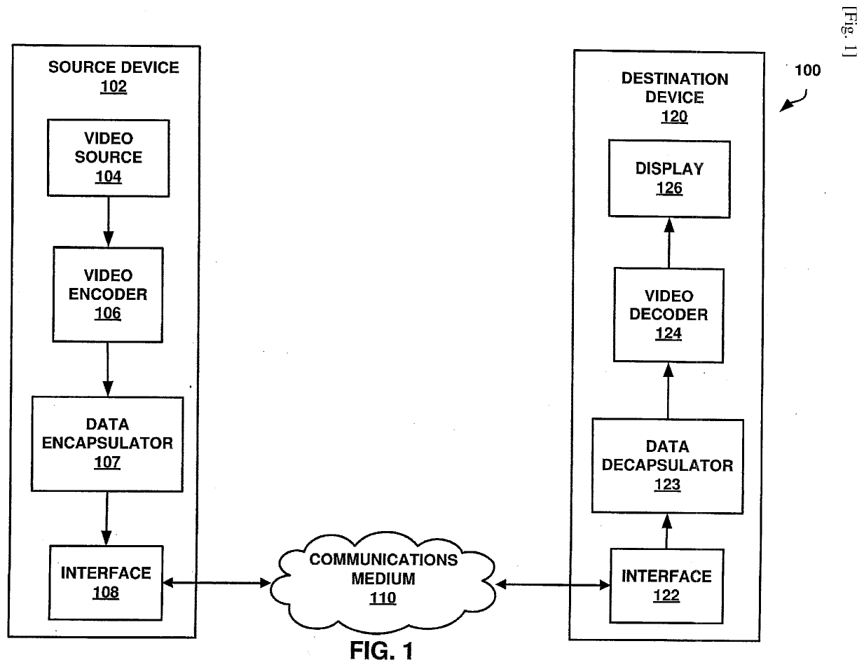

FIG. 1 is a block diagram illustrating an example of a system that may be configured to code (i.e., encode and/or decode) video data according to one or more techniques of this disclosure. System 100 represents an example of a system that may encapsulate video data according to one or more techniques of this disclosure. As illustrated in FIG. 1, system 100 includes source device 102, communications medium 110, and destination device 120. In the example illustrated in FIG. 1, source device 102 may include any device configured to encode video data and transmit encoded video data to communications medium 110. Destination device 120 may include any device configured to receive encoded video data via communications medium 110 and to decode encoded video data. Source device 102 and/or destination device 120 may include computing devices equipped for wired and/or wireless communications and may include, for example, set top boxes, digital video recorders, televisions, desktop, laptop or tablet computers, gaming consoles, medical imagining devices, and mobile devices, including, for example, smartphones, cellular telephones, personal gaming devices.

Communications medium 110 may include any combination of wireless and wired communication media, and/or storage devices. Communications medium 110 may include coaxial cables, fiber optic cables, twisted pair cables, wireless transmitters and receivers, routers, switches, repeaters, base stations, or any other equipment that may be useful to facilitate communications between various devices and sites. Communications medium 110 may include one or more networks. For example, communications medium 110 may include a network configured to enable access to the World Wide Web, for example, the Internet. A network may operate according to a combination of one or more telecommunication protocols. Telecommunications protocols may include proprietary aspects and/or may include standardized telecommunication protocols. Examples of standardized telecommunications protocols include Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, Global System Mobile Communications (GSM) standards, code division multiple access (CDMA) standards, 3rd Generation Partnership Project (3GPP) standards, European Telecommunications Standards Institute (ETSI) standards, Internet Protocol (IP) standards, Wireless Application Protocol (WAP) standards, and Institute of Electrical and Electronics Engineers (IEEE) standards.

Storage devices may include any type of device or storage medium capable of storing data. A storage medium may include a tangible or non-transitory computer-readable media. A computer readable medium may include optical discs, flash memory, magnetic memory, or any other suitable digital storage media. In some examples, a memory device or portions thereof may be described as non-volatile memory and in other examples portions of memory devices may be described as volatile memory. Examples of volatile memories may include random access memories (RAM), dynamic random access memories (DRAM), and static random access memories (SRAM). Examples of non-volatile memories may include magnetic hard discs, optical discs, floppy discs, flash memories, or forms of electrically programmable memories (EPROM) or electrically erasable and programmable (EEPROM) memories. Storage device(s) may include memory cards (e.g., a Secure Digital (SD) memory card), internal/external hard disk drives, and/or internal/external solid state drives. Data may be stored on a storage device according to a defined file format.

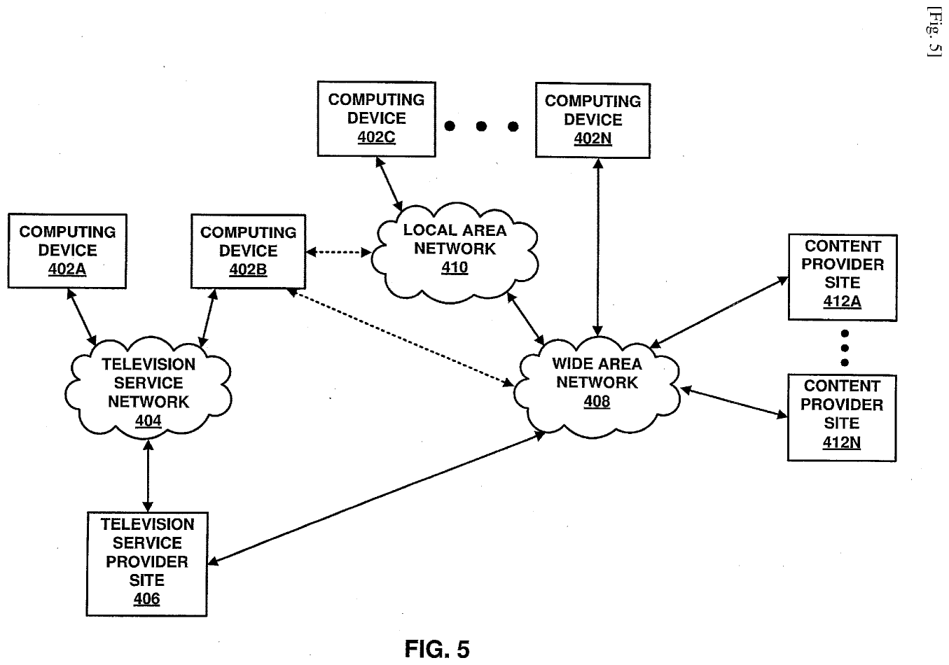

FIG. 5 is a conceptual drawing illustrating an example of components that may be included in an implementation of system 100. In the example implementation illustrated in FIG. 5, system 100 includes one or more computing devices 402A-402N, television service network 404, television service provider site 406, wide area network 408, local area network 410, and one or more content provider sites 412A-412N. The implementation illustrated in FIG. 5 represents an example of a system that may be configured to allow digital media content, such as, for example, a movie, a live sporting event, etc., and data and applications and media presentations associated therewith to be distributed to and accessed by a plurality of computing devices, such as computing devices 402A-402N. In the example illustrated in FIG. 5, computing devices 402A-402N may include any device configured to receive data from one or more of television service network 404, wide area network 408, and/or local area network 410. For example, computing devices 402A-402N may be equipped for wired and/or wireless communications and may be configured to receive services through one or more data channels and may include televisions, including so-called smart televisions, set top boxes, and digital video recorders. Further, computing devices 402A-402N may include desktop, laptop, or tablet computers, gaming consoles, mobile devices, including, for example, “smart” phones, cellular telephones, and personal gaming devices.

Television service network 404 is an example of a network configured to enable digital media content, which may include television services, to be distributed. For example, television service network 404 may include public over-the-air television networks, public or subscription-based satellite television service provider networks, and public or subscription-based cable television provider networks and/or over the top or Internet service providers. It should be noted that although in some examples television service network 404 may primarily be used to enable television services to be provided, television service network 404 may also enable other types of data and services to be provided according to any combination of the telecommunication protocols described herein. Further, it should be noted that in some examples, television service network 404 may enable two-way communications between television service provider site 406 and one or more of computing devices 402A-402N. Television service network 404 may comprise any combination of wireless and/or wired communication media. Television service network 404 may include coaxial cables, fiber optic cables, twisted pair cables, wireless transmitters and receivers, routers, switches, repeaters, base stations, or any other equipment that may be useful to facilitate communications between various devices and sites. Television service network 404 may operate according to a combination of one or more telecommunication protocols. Telecommunications protocols may include proprietary aspects and/or may include standardized telecommunication protocols. Examples of standardized telecommunications protocols include DVB standards, ATSC standards, ISDB standards, DTMB standards, DMB standards, Data Over Cable Service Interface Specification (DOCSIS) standards, HbbTV standards, W3C standards, and UPnP standards.

Referring again to FIG. 5, television service provider site 406 may be configured to distribute television service via television service network 404. For example, television service provider site 406 may include one or more broadcast stations, a cable television provider, or a satellite television provider, or an Internet-based television provider. For example, television service provider site 406 may be configured to receive a transmission including television programming through a satellite uplink/downlink. Further, as illustrated in FIG. 5, television service provider site 406 may be in communication with wide area network 408 and may be configured to receive data from content provider sites 412A-412N. It should be noted that in some examples, television service provider site 406 may include a television studio and content may originate therefrom.

Wide area network 408 may include a packet based network and operate according to a combination of one or more telecommunication protocols. Telecommunications protocols may include proprietary aspects and/or may include standardized telecommunication protocols. Examples of standardized telecommunications protocols include Global System Mobile Communications (GSM) standards, code division multiple access (CDMA) standards, 3^{rd} Generation Partnership Project (3GPP) standards, European Telecommunications Standards Institute (ETSI) standards, European standards (EN), IP standards, Wireless Application Protocol (WAP) standards, and Institute of Electrical and Electronics Engineers (IEEE) standards, such as, for example, one or more of the IEEE 802 standards (e.g., Wi-Fi). Wide area network 408 may comprise any combination of wireless and/or wired communication media. Wide area network 480 may include coaxial cables, fiber optic cables, twisted pair cables, Ethernet cables, wireless transmitters and receivers, routers, switches, repeaters, base stations, or any other equipment that may be useful to facilitate communications between various devices and sites. In one example, wide area network 408 may include the Internet. Local area network 410 may include a packet based network and operate according to a combination of one or more telecommunication protocols. Local area network 410 may be distinguished from wide area network 408 based on levels of access and/or physical infrastructure. For example, local area network 410 may include a secure home network.

Referring again to FIG. 5, content provider sites 412A-412N represent examples of sites that may provide multimedia content to television service provider site 406 and/or computing devices 402A-402N. For example, a content provider site may include a studio having one or more studio content servers configured to provide multimedia files and/or streams to television service provider site 406. In one example, content provider sites 412A-412N may be configured to provide multimedia content using the IP suite. For example, a content provider site may be configured to provide multimedia content to a receiver device according to Real Time Streaming Protocol (RTSP), HTTP, or the like. Further, content provider sites 412A-412N may be configured to provide data, including hypertext based content, and the like, to one or more of receiver devices computing devices 402A-402N and/or television service provider site 406 through wide area network 408. Content provider sites 412A-412N may include one or more web servers. Data provided by data provider site 412A-412N may be defined according to data formats.

Referring again to FIG. 1, source device 102 includes video source 104, video encoder 106, data encapsulator 107, and interface 108. Video source 104 may include any device configured to capture and/or store video data. For example, video source 104 may include a video camera and a storage device operably coupled thereto. Video encoder 106 may include any device configured to receive video data and generate a compliant bitstream representing the video data. A compliant bitstream may refer to a bitstream that a video decoder can receive and reproduce video data therefrom. Aspects of a compliant bitstream may be defined according to a video coding standard. When generating a compliant bitstream video encoder 106 may compress video data. Compression may be lossy (discernible or indiscernible to a viewer) or lossless.

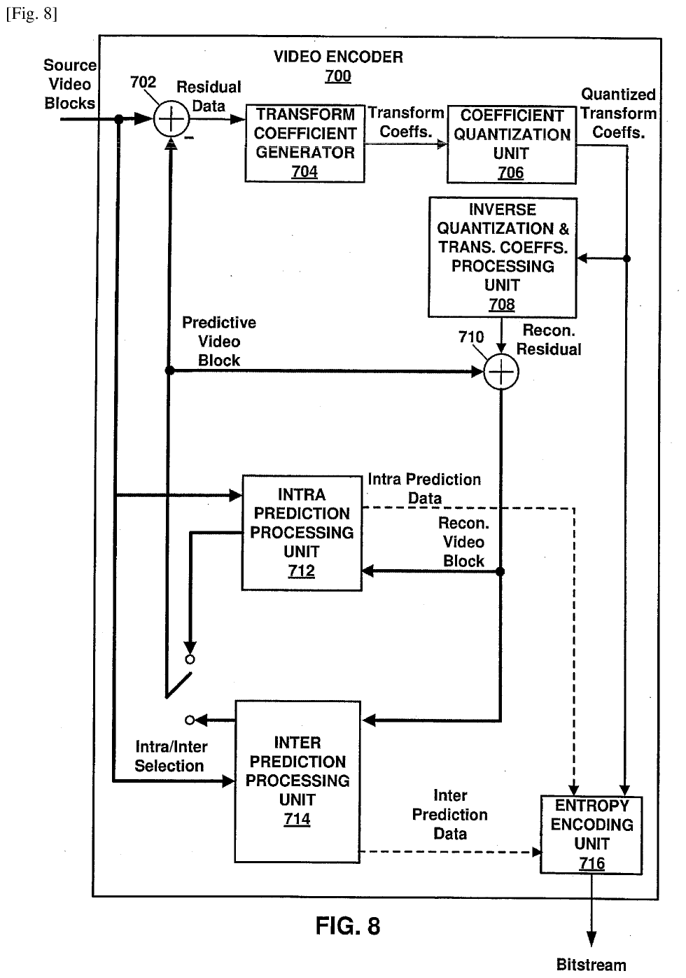

FIG. 8 is a block diagram illustrating an example of video encoder 700 that may implement the techniques for encoding video data described herein. It should be noted that although example video encoder 700 is illustrated as having distinct functional blocks, such an illustration is for descriptive purposes and does not limit video encoder 700 and/or sub-components thereof to a particular hardware or software architecture. Functions of video encoder 700 may be realized using any combination of hardware, firmware, and/or software implementations.

Video encoder 700 may perform intra prediction coding and inter prediction coding of picture areas, and, as such, may be referred to as a hybrid video encoder. In the example illustrated in FIG. 8, video encoder 700 receives source video blocks. In some examples, source video blocks may include areas of picture that has been divided according to a coding structure. For example, source video data may include macroblocks, CTUs, CBs, sub-divisions thereof, and/or another equivalent coding unit. In some examples, video encoder 700 may be configured to perform additional sub-divisions of source video blocks. It should be noted that the techniques described herein are generally applicable to video coding, regardless of how source video data is partitioned prior to and/or during encoding. In the example illustrated in FIG. 8, video encoder 700 includes summer 702, transform coefficient generator 704, coefficient quantization unit 706, inverse quantization and transform coefficient processing unit 708, summer 710, intra prediction processing unit 712, inter prediction processing unit 714, and entropy encoding unit 716. As illustrated in FIG. 8, video encoder 700 receives source video blocks and outputs a bitstream.

In the example illustrated in FIG. 8, video encoder 700 may generate residual data by subtracting a predictive video block from a source video block. The selection of a predictive video block is described in detail below. Summer 702 represents a component configured to perform this subtraction operation. In one example, the subtraction of video blocks occurs in the pixel domain. Transform coefficient generator 704 applies a transform, such as a discrete cosine transform (DCT), a discrete sine transform (DST), or a conceptually similar transform, to the residual block or sub-divisions thereof (e.g., four 8×8 transforms may be applied to a 16×16 array of residual values) to produce a set of residual transform coefficients. Transform coefficient generator 704 may be configured to perform any and all combinations of the transforms included in the family of discrete trigonometric transforms, including approximations thereof. Transform coefficient generator 704 may output transform coefficients to coefficient quantization unit 706. Coefficient quantization unit 706 may be configured to perform quantization of the transform coefficients. The quantization process may reduce the bit depth associated with some or all of the coefficients. The degree of quantization may alter the rate-distortion (i.e., bit-rate vs. quality of video) of encoded video data. The degree of quantization may be modified by adjusting a quantization parameter (QP). A quantization parameter may be determined based on slice level values and/or CU level values (e.g., CU delta QP values). QP data may include any data used to determine a QP for quantizing a particular set of transform coefficients. As illustrated in FIG. 8, quantized transform coefficients (which may be referred to as level values) are output to inverse quantization and transform coefficient processing unit 708. Inverse quantization and transform coefficient processing unit 708 may be configured to apply an inverse quantization and an inverse transformation to generate reconstructed residual data. As illustrated in FIG. 8, at summer 710, reconstructed residual data may be added to a predictive video block. In this manner, an encoded video block may be reconstructed and the resulting reconstructed video block may be used to evaluate the encoding quality for a given prediction, transformation, and/or quantization. Video encoder 700 may be configured to perform multiple coding passes (e.g., perform encoding while varying one or more of a prediction, transformation parameters, and quantization parameters). The rate-distortion of a bitstream or other system parameters may be optimized based on evaluation of reconstructed video blocks. Further, reconstructed video blocks may be stored and used as reference for predicting subsequent blocks.

Referring again to FIG. 8, intra prediction processing unit 712 may be configured to select an intra prediction mode for a video block to be coded. Intra prediction processing unit 712 may be configured to evaluate a frame and determine an intra prediction mode to use to encode a current block. As described above, possible intra prediction modes may include planar prediction modes, DC prediction modes, and angular prediction modes. Further, it should be noted that in some examples, a prediction mode for a chroma component may be inferred from a prediction mode for a luma prediction mode. Intra prediction processing unit 712 may select an intra prediction mode after performing one or more coding passes. Further, in one example, intra prediction processing unit 712 may select a prediction mode based on a rate-distortion analysis. As illustrated in FIG. 8, intra prediction processing unit 712 outputs intra prediction data (e.g., syntax elements) to entropy encoding unit 716 and transform coefficient generator 704.

Referring again to FIG. 8, inter prediction processing unit 714 may be configured to perform inter prediction coding for a current video block. Inter prediction processing unit 714 may be configured to receive source video blocks and calculate a motion vector for PUs of a video block. A motion vector may indicate the displacement of a PU of a video block within a current video frame relative to a predictive block within a reference frame. Inter prediction coding may use one or more reference pictures. Further, motion prediction may be uni-predictive (use one motion vector) or bipredictive (use two motion vectors). Inter prediction processing unit 714 may be configured to select a predictive block by calculating a pixel difference determined by, for example, sum of absolute difference (SAD), sum of square difference (SSD), or other difference metrics. As described above, a motion vector may be determined and specified according to motion vector prediction. Inter prediction processing unit 714 may be configured to perform motion vector prediction, as described above. Inter prediction processing unit 714 may be configured to generate a predictive block using the motion prediction data. For example, inter prediction processing unit 714 may locate a predictive video block within a frame buffer (not shown in FIG. 8). It should be noted that inter prediction processing unit 714 may further be configured to apply one or more interpolation filters to a reconstructed residual block to calculate sub-integer pixel values for use in motion estimation. Inter prediction processing unit 714 may output motion prediction data for a calculated motion vector to entropy encoding unit 716.

Referring again to FIG. 8, entropy encoding unit 718 receives quantized transform coefficients and predictive syntax data (i.e., intra prediction data and motion prediction data). It should be noted that in some examples, coefficient quantization unit 706 may perform a scan of a matrix including quantized transform coefficients before the coefficients are output to entropy encoding unit 718. In other examples, entropy encoding unit 718 may perform a scan. Entropy encoding unit 718 may be configured to perform entropy encoding according to one or more of the techniques described herein. Entropy encoding unit 718 may be configured to output a compliant bitstream, i.e., a bitstream that a video decoder can receive and reproduce video data therefrom. In this manner, video encoder 700 represents an example of a device configured to generate encoded video data according to one or more techniques of this disclose. In one example, video encoder 700 may generate encoded video data that may be used for omnidirectional video.

Referring again to FIG. 1, data encapsulator 107 may receive encoded video data and generate a compliant bitstream, e.g., a sequence of NAL units according to a defined data structure. A device receiving a compliant bitstream can reproduce video data therefrom. It should be noted that the term conforming bitstream may be used in place of the term compliant bitstream. As described above, the techniques SEI message for region-wise packing specified in Boyce may be less than ideal. In one example, data encapsulator 107 may be configured to signal information associated with region-wise packing according to one or more techniques described herein. It should be noted that data encapsulator 107 need not necessary be located in the same physical device as video encoder 106. For example, functions described as being performed by video encoder 106 and data encapsulator 107 may be distributed among devices illustrated in FIG. 5.

Table 3 provides example syntax of a region-wise packing SEI message that may be generated by data encapsulator 107 according to the techniques described herein.

TABLE 3

| | |
|---|---|
| regionwise_packing(payloadSize) { | Descriptor |
| rwp_cancel_flag | u(1) |
| if( !rwp_cancel_flag) { | |
| rwp_persistence_flag | u(1) |
| constitutent_picture_matching_reg | u(1) |
| rwp_reserved_zero_5bits | u(5) |
| num_packed_regions | u(8) |
| proj_picture_width | u(16) |
| proj_picture_height | u(16) |
| packed_picture_width | u(16) |
| packed_piclare_height | u(16) |
| for( i = 0; i < num_packed_regions; i++) { | |
| rwp_reserved_zero_4bits[i] | u(4) |
| packing_type[i] | u(4) |
| if( packing_type[i] == 0 ) { | |
| proj_region _width[i] | u(16) |
| proj_region_height[i] | u(16) |
| pro_region_top[i] | u(16) |
| proj_region_left[i] | u(16) |
| transform_type[i] | u(3) |
| rwp_reserved_zero_5bits[i] | u(5) |
| packed_region_width[i] | u(16) |
| packed_region_height[i] | u(16) |
| packed_region_top[i] | u(16) |
| packed_region_left[i] | u(16) |
| } | |
| } | |
| } | |
| } | |

With respect to Table 3, the following example semantics may be used for the Region-wise packing SEI message:

If a frame packing arrangement SEI message with frame_packing_arrangement_cancel_flag equal to 0 that applies to the picture is not present, StereoFlag, TopBottomFlag, and SideBySideFlag are all set equal to 0, HorDiv1 is set equal to 1, and VerDiv1 is set equal to 1.

Otherwise, the following applies:
StereoFlag is set equal to 1.
If the value of frame_packing_arrangement_type of the frame packing arrangement SEI message is equal to 3, TopBottomFlag is set equal to 0, SideBySideFlag is set equal to 1, HorDiv1 is set equal to 2 and VerDiv1 is set equal to 1.
Otherwise, if the value of frame_packing_arrangement_type of the frame packing arrangement SEI message is equal to 4, TopBottomFlag is set equal to 1, SideBySideFlag is set equal to 0, HorDiv1 is set equal to 1, and VerDiv1 is set equal to 2.
Otherwise, TopBottomFlag is set equal to 0, SideBySideFlag is set equal to 0, HorDiv1 is set equal to 1, and VerDiv1 is set equal to 1.
   The region-wise packing SEI message provides information to enable remapping of the colour samples of the cropped output pictures onto projected pictures. rwp_cancel_flag equal to 1 indicates that the SEI message cancels the persistence of any previous region-wise packing SEI message in output order. rwp_cancel_flag equal to 0 indicates that region-wise packing information follows.
   rwp_persistence_flag specifies the persistence of the region-wise packing SEI message for the current layer.
   rwp_persistence_flag equal to 0 specifies that the region-wise packing SEI message applies to the current decoded picture only.
   Let picA be the current picture. rwp_persistence_flag equal to 1 specifies that the region-wise packing SEI message persists for the current layer in output order until one or more of the following conditions are true:
A new CLVS of the current layer begins.
The bitstream ends.
A picture picB in the current layer in an access unit containing a region-wise packing SEI message that is applicable to the current layer is output for which PicOrderCnt(picB) is greater than PicOrderCnt(picA), where PicOrderCnt(picB) and PicOrderCnt(picA) are the PicOrderCntVal values of picB and picA, respectively, immediately after the invocation of the decoding process for picture order count for picB. When an equirectangular projection SEI message with erp_cancel_flag equal to 0 or a cubemap projection SEI message with cmp_cancel_flag equal to 0 is not present in the CLVS that applies to the current picture and precedes the region-wise packing SEI message in decoding order, a region-wise packing SEI message with rwp_persistence_flag equal to 0 shall not be present in the CLVS that applies to the current picture. Decoders shall ignore region-wise packing SEI messages with rwp_persistence_flag equal to 0 that do not follow, in decoding order, an equirectangular projection SEI message with erp_cancel_flag equal to 0 or a cubemap projection SEI message with cmp_cancel_flag equal to 0 in the CLVS that applies to the current picture.
   constituent_picture_matching_reg equal to 1 specifies that the projected region information, packed region information in this SEI message applies individually to each constituent picture and that the packed picture and the projected picture have the same stereoscopic frame packing format indicated by the frame packing arrangement SEI message that applies to the picture. constituent_picture_matching_reg equal to 0 specifies that the projected region information, packed region information in this SEI message apply to the projected picture. When StereoFlag is equal to 0 or StereoFlag is equal to 1 and frame_packing_arrangement_type of the frame packing arrangement SEI message that applies to the picture is equal to 5, constituent_picture_matching_reg shall be equal to 0.
   rwp_reserved_zero_5bits shall be equal to 0 in bitstreams conforming to this version of this Specification. Other values for rwp_reserved_zero_5bits[i] are reserved for future use by ITU-T|ISO/IEC. Decoders shall ignore the value of rwp_reserved_zero_5bits[i].
   num_packed_regions specifies the number of packed regions for which the projected region information, and packed region information, is indicated in this SEI message. The value of num_packed_regions shall be greater than 0. When constituent_picture_matching_reg is equal to 1, the total number of packed regions is equal to 2*num_packed_regions and the information in the projected and packed region information in the SEI message applies to each constituent picture of the projected picture and the packed picture.
   proj_picture_width and proj_picture_height specify the width and height, respectively, of the projected picture. The value of proj_picture_width and proj_picture_height shall be both greater than 0.
   packed_picture_width and packed_picture_height specify the width and height, respectively, of the packed picture, in relative packed picture sample units. packed_picture_width and packed_picture_height shall both be greater than 0. rwp_reserved_zero_4bits shall be equal to 0 in bitstreams conforming to this version of this Specification. Other values for rwp_reserved_zero_4bits[i] are reserved for future use by ITU-T|ISO/IEC. Decoders shall ignore the value of rwp_reserved_zero_4bits[i].
   packing_type[i] specifies the type of region-wise packing. packing_type[i] equal to 0 indicates rectangular region-wise packing. Other values are reserved. The value of packing_type[i] shall be equal to 0 in this version of this Specification. Decoders shall allow values of packing_type[i] greater than 0 and shall ignore all region-wise packing SEI messages with packing_type[i] greater than 0 for any value of i. proj_region_width[i], proj_region_height[i], proj_region_top[i], and proj_region_left[i] are indicated in units of luma samples in a projected picture with width and height equal to proj_picture_width and proj_picture_height, respectively.
   proj_region_width[i] specifies the width of the i-th projected region.
   proj_region_height[i] specifies the height of the i-th projected region.
   proj_region_top[i] and proj_region_left[i] specify the top luma sample row and the left-most luma sample column, respectively, of the i-th projected region in the projected picture when constituent_picture_matching_reg is equal to 0, or in the constituent picture of the projected picture when constituent_picture_matching_reg is equal to 1. The values of proj_region_top[i] and proj_region_left[i], shall be in the range from 0, inclusive, indicating the top-left corner of the projected picture, to proj_picture_height−1, inclusive, and proj_picture_width−1, inclusive, respectively. The values of proj_region_width[i], proj_region_height[i], proj_region_top[i], and proj_region_left[i] are constrained as follows:
If StereoFlag is equal to 0 or TopBottomFlag is equal to 1, proj_region_width[i] shall be in the range of 1 to proj_picture_width, inclusive.
Otherwise (SideBySideFlag is equal to 1), proj_region_width[i] shall be in the range of 1 to proj_picture_width/2, inclusive.
proj_region_height[i] shall be greater than 0.
When constituent_picture_matching_reg is equal to 0, the values of proj_region_top[i] and proj_region_left[i] shall be in the range from 0, inclusive, indicating the top-left corner of the projected picture, to proj_picture_height−1, inclusive, and proj_picture_width−1, inclusive, respectively. When constituent_picture_matching_reg is equal to 1, the values of proj_region_top[i] and proj_region_left[i] shall be in the range from 0, inclusive, to proj_picture_height/VerDiv1−1, inclusive, and proj_picture_width/HorDiv1−1, inclusive, respectively.
When StereoFlag is equal to 0 or constituent_picture_matching_reg is equal to 0, proj_region_height[i] and proj_region_top[i] shall be constrained such that proj_region_height[i]+proj_region_top[i]−1 is less than proj_picture_height.
When StereoFlag is equal to 1 and the value of frame_packing_arrangement_type of the frame packing arrangement SEI message is equal to 3 or 4, the following applies:
   proj region_width[i] shall be less than or equal to proj_picture_width/HorDiv1.
   proj_region_height[i] shall be less than or equal to proj_picture_height/VerDiv1.
   If proj_region_left[i] is less than proj_picture_width/HorDiv1, proj_region_width[i] and proj_region_left[i] shall be constrained such that proj_region_width[i]+proj region_left[i]−1 is less than proj_picture_width/HorDiv1.
   Otherwise (proj_region_left[i] is greater than or equal to proj_picture_width/HorDiv1), proj_region_width[i] and proj_region_left[i] shall be constrained such that proj_region_width[i]+proj_region_left[i]−proj_picture_width/HorDiv1−1 is less than proj_picture_width/HorDiv1.
   If proj_region_top[i] is less than proj_picture_height/VerDiv1 then proj_region_height[i] and proj region top[i] shall be constrained such that proj_region_height[i]+proj_region_top[i]−1 is less than proj_picture_height/VerDiv1.
   Otherwise (i.e. when proj_region_top[i] is greater than or equal to proj_picture_height/VerDiv1) then proj_region_height[i] and proj_region_top[i] shall be constrained such that proj_region_height[i]+proj_region_top[i]−proj_picture height/VerDiv1−1 is less than proj_picture_height/VerDiv1.
When constituent_picture_matching_reg is equal to 1, the following applies:
   proj_region_width[i] and proj_region_left[i] shall be constrained such that proj region width[i]+proj_region_left[i]−1 is less than proj_picture_width/HorDiv1.
   proj_region_height[i] and proj region_top[i] shall be constrained such that proj_region_height[i]+proj_region_top[i]−1 is less than proj_picture_height/VerDiv1.

NOTE—Two projected regions may partially or entirely overlap with each other.

transform_type[i] specifies the rotation and mirroring to be applied to the i-th packed region to remap to the i-th projected region. When transform_type[i] specifies both rotation and mirroring, rotation applies before mirroring. The values of transform_type[i] are specified in Table D. X:

TABLE D.X
transform_type[i] values

| Value | Description |
|---|---|
| 0 | no transform |
| 1 | mirroring horizontally |
| 2 | rotation by 180 degrees (counter-clockwise) |
| 3 | rotation by 180 degrees (counter-clockwise) after mirroring |
| | horizontally |
| 4 | rotation by 90 degrees (counter-clockwise) before mirroring |
| | horizontally |
| 5 | rotation by 90 degrees (counter-clockwise) |
| 6 | rotation by 270 degrees (counter-clockwise) before |
| | mirroring horizontally |
| 7 | rotation by 270 degrees (counter-clockwise) |

rwp_reserved_zero_5bits shall be equal to 0 in bitstreams conforming to this version of this Specification. Other values for rwp_reserved_zero_5bits[i] are reserved for future use by ITU-T|ISO/IEC. Decoders shall ignore the value of rwp_reserved_zero_5bits[i].

packed_region_width[i], packed_region_height[i], packed_region_top[i], and packed_region_left[i] specify the width, height, the top luma sample row, and the left-most luma sample column, respectively, of the packed region in the region-wise packed picture.

Let packedPicWidth and packedPicHeight be the width and height of the conformance cropping window of the region-wise packed picture. The values of packed_region_width[i], packed_region_height[i], packed_region_top[i], and packed_region_left[i] are constrained as follows:
packed_region_width[i] and packed_region_height[i] shall both be greater than 0.
The values of packed_region_top[i] and packed_region_left[i] shall be in the range from 0, inclusive, indicating the top-left corner luma sample of the region-wise packed picture, to packed_picture_height−1, inclusive, and packed_picture_width−1, inclusive, respectively.
If constituent_picture_matching_region is equal to 0, then the following applies:
   The sum of packed region width[i] and packed region left[i] shall be less than packedPicWidth.
   The sum of packed region_height[i] and packed region top[i] shall be less than packedPicHeight.
Otherwise (constituent_picture_matching_reg is equal to 1), the following applies:
   The sum of packed_reg_width[i] and packed_reg_left[i] minus 1 shall be less than packed_picture_width/HorDiv1.
   The sum of packed_reg_height[i] and packed_reg_top[i] minus 1 shall be less than packed_picture_height/VerDiv1.
      The rectangle specified by packed_region_width[i], packed_region_height[i], packed_region_top[i], and packed_region_left[i] shall be non-overlapping with the rectangle specified by packed_region_width[j], packed_region_height[j], packed_region_top[j], and packed_region_left[j] for any value of j in the range of 0 to i−1, inclusive.

In one example, with respect to constituent_picture_matching_reg, the following semantics may apply:

constituent_picture_matching_reg shall be equal to 1 only if StereoFlag is equal to 1 and frame_packing_arrangement_type of the frame packing arrangement SEI message that applies to the picture is equal to 3 or 4.

In one example, with respect to constituent_picture_matching_reg, the following semantics may apply:

constituent_picture_matching_reg equal to 1 specifies that the projected region information, packed region information in this SEI message applies individually to each constituent picture. constituent_picture_matching_reg equal to 0 specifies that the projected region information, packed region information in this SEI message apply to the projected picture.

If a frame packing arrangement SEI message with frame_packing_arrangement_cancel_flag equal to 0 that applies to the picture is not present or it is present and the value of frame_packing_arrangement_type in that SEI message is equal to 5, constituent_picture_matching_reg shall be equal to 0.

As described above, in ITU-T H.265, parameter sets may be encapsulated as a special type of NAL unit or may be signaled as a message and ITU-T H.265 enables video usability information messages to be signaled. In one example, instead of signaling constituent_picture_matching_reg in a region-wise packing SEI, this flag and/or one or more syntax elements in the region-wise packing SEI message may be signalled in a parameter set. In one example this signaling may be done in SPS VUI. In another example, this signaling may be done in VPS VUI.

In this manner, data encapsulator 107 represents an example of a device configured to signal information associated with constituent picture matching regions.

Referring again to FIG. 1, interface 108 may include any device configured to receive data generated by data encapsulator 107 and transmit and/or store the data to a communications medium. Interface 108 may include a network interface card, such as an Ethernet card, and may include an optical transceiver, a radio frequency transceiver, or any other type of device that can send and/or receive information. Further, interface 108 may include a computer system interface that may enable a file to be stored on a storage device. For example, interface 108 may include a chipset supporting Peripheral Component Interconnect (PCI) and Peripheral Component Interconnect Express (PCIe) bus protocols, proprietary bus protocols, Universal Serial Bus (USB) protocols, I²C, or any other logical and physical structure that may be used to interconnect peer devices.

Referring again to FIG. 1, destination device 120 includes interface 122, data decapsulator 123, video decoder 124, and display 126. Interface 122 may include any device configured to receive data from a communications medium. Interface 122 may include a network interface card, such as an Ethernet card, and may include an optical transceiver, a radio frequency transceiver, or any other type of device that can receive and/or send information. Further, interface 122 may include a computer system interface enabling a compliant video bitstream to be retrieved from a storage device. For example, interface 122 may include a chipset supporting PCI and PCIe bus protocols, proprietary bus protocols, USB protocols, I²C, or any other logical and physical structure that may be used to interconnect peer devices. Data decapsulator 123 may be configured to receive a bitstream and metadata generated by data encaspulator 107 and perform a reciprocal decapsulation process.

Video decoder 124 may include any device configured to receive a bitstream and/or acceptable variations thereof and reproduce video data therefrom. Display 126 may include any device configured to display video data. Display 126 may comprise one of a variety of display devices such as a liquid crystal display (LCD), a plasma display, an organic light emitting diode (OLED) display, or another type of display. Display 126 may include a High Definition display or an Ultra High Definition display. Display 126 may include a stereoscopic display. It should be noted that although in the example illustrated in FIG. 1, video decoder 124 is described as outputting data to display 126, video decoder 124 may be configured to output video data to various types of devices and/or sub-components thereof. For example, video decoder 124 may be configured to output video data to any communication medium, as described herein.

As described above, the process for mapping of luma sample locations within a region-wise packed picture to sphere coordinates relative to the global coordinate axes, described in Choi and Boyce may be less than ideal. In one example, destination device 120 may be configured to map of luma sample locations within a region-wise packed picture to sphere coordinates relative to the global coordinate axes by setting values of the variables NumRegions, PackedRegLeft[n], PackedRegTop[n], PackedRegWidth[n], PackedRegHeight[n], ProjRegLeft[n], ProjRegTop[n], ProjPictureWidth[n], ProjPictureHeight[n], TrasnformType[n], PackingType[n] as follows:
If constituent_picture_matching_regions is equal to 0,
   NumRegions is set equal to num_regions
   For n in the range of 0 to NumRegions−1:
      PackedRegLeft[n] is set equal to packed_reg_left[n]
      PackedRegTop[n] is set equal to packed_reg_top[n]
      PackedRegWidth[n] is set equal to packed_reg_width[n]
      PackedRegHeight[n] is set equal to packed_reg_height[n]
      ProjRegLeft[n] is set equal to projreg_left[n]
      ProjRegTop[n] is set equal to proj_reg_top[n]
      ProjRegWidth[n] is set equal to proj_reg_width[n]
      ProjRegHeight[n] is set equal to proj_reg_height[n]
      TransformType[n] is set equal to transform_type[n]
      PackingType[n] is set equal to packing_type[n]
If constituent_picture_matching_regions is equal to 1,
   NumRegions is set equal to 2*num_regions
   When TopBottomFlag is set equal to 1 following variables are set:
      ProjLeftOffset and PackedLeftOffset are both set equal to 0
      ProjTopOffset is set equal to proj_picture_height/2 and PackedTopOffset is set equal to packed_pictureheight/2
   When SideBySideFlag is set equal to 1 following variables are set:
      ProjLeftOffset is set equal to proj_picture_width/2 and PackedLeftOffset is set equal to packed_picture_width/2
      ProjTopOffset and PackedTopOffset are both set equal to 0
   For n in the range of 0 to NumRegions/2−1:
      PackedRegLeft[n] is set equal to packed_reg_left[n]
      PackedRegTop[n] is set equal to packed_reg_top[n]
      PackedRegWidth[n] is set equal to packed_reg_width[n]
      PackedRegHeight[n] is set equal to packed_reg_height[n]
      ProjRegLeft[n] is set equal to proj_reg_left[n]
      ProjRegTop[n] is set equal to proj_reg_top[n]
      ProjRegWidth[n] is set equal to proj_reg_width[n]
      ProjRegHeight[n] is set equal to proj_reg_height[n]
      TransformType[n] is set equal to transform_type[n]
      PackingType[n] is set equal to packing type[n]
   For n in the range of NumRegion/2 to NumRegions−1: NIdx is set equal to (n−NumRegion/2)
      PackedRegLeft[n] is set equal to packed_reg_left[NIdx]+PackedLeftOffset
      PackedRegTop[n] is set equal to packed_reg_top[NIdx]+PackedTopOffset
      PackedRegWidth[n] is set equal to packed_reg_width[NIdx]
      PackedRegHeight[n] is set equal to packed_reg_height[NIdx]
      ProjRegLeft[n] is set equal to proj_reg_left[NIdx]+ProjLeftOffset
      ProjRegTop[n] is set equal to proj_reg_top[NIdx]+ProjTopOffset
      ProjRegWidth[n] is set equal to proj_reg_width[NIdx]
      ProjRegHeight[n] is set equal to proj_reg_height[NIdx]
      TransformType[n] is set equal to transform_type[NIdx]
      PackingType[n] is set equal to packing type[NIdx]

Thus, it should be noted that with respect to the notation used in Choi, the process for mapping of luma sample locations within a region-wise packed picture to sphere coordinates relative to the global coordinate axes may be specified as follows:

This clause specifies the semantics of luma sample locations within a decoded picture to sphere coordinates relative to the global coordinate axes. The decoded picture can be of any of the following:
When SubPictureCompositionBox is not present in a projected omnidirectional video track, the decoded picture is the decoding output resulting from a sample of the track.
When SubPictureCompositionBox is present in a projected omnidirectional video track, the decoded picture is a composition picture constructed as specified in 7.1.1.1 [of Choi].
For an image item, the decoded picture is a reconstructed image of the image item. This clause uses variables HorDiv1, VerDiv1, RotationFlag, StereoFlag, TopBottomFlag, SideBySideFlag, MonoPicWidth, MonoPicHeight, and RegionWisePackingFlag that are derived specific to the type of the decoded picture for which this clause is applied.
   offsetX is set equal to 0.5 and offsetY is set equal to 0.5.
   The values of the variables NumRegions, PackedRegLeft[n], PackedRegTop[n], PackedRegWidth[n], PackedRegHeight[n], ProjRegLeft[n], ProjRegTop[n], ProjPictureWidth[n], ProjPictureHeight[n], TrasnformType[n], PackingType[n] are set as follows:
If constituent_picture_matching_regions is equal to 0,
   NumRegions is set equal to num_regions
   For n in the range of 0 to NumRegions−1:
      PackedRegLeft[n] is set equal to packed_reg_left[n]
      PackedRegTop[n] is set equal to packed_reg_top[n]
      PackedRegWidth[n] is set equal to packed_reg_width[n]
      PackedRegHeight[n] is set equal to packed_reg_height[n]
      ProjRegLeft[n] is set equal to proj_reg_left[n]
      ProjRegTop[n] is set equal to proj_reg_top[n]
      ProjRegWidth[n] is set equal to proj_reg_width[n]
      ProjRegHeight[n] is set equal to proj_reg_height[n]
      TransformType[n] is set equal to transform_type[n]
      PackingType[n] is set equal to packing type[n]
If constituent_picture_matching_regions is equal to 1,
   NumRegions is set equal to 2*num_regions
   When TopBottomFlag is set equal to 1 following variables are set:
      ProjLeftOffset and PackedLeftOffset are both set equal to 0
      ProjTopOffset is set equal to proj_picture_height/2 and PackedTopOffset is set equal to packed_picture_height/2
   When SideBySideFlag is set equal to 1 following variables are set:
      ProjLeftOffset is set equal to proj_picture_width/2 and PackedLeftOffset is set equal to packed_picture_width/2
      ProjTopOffset and PackedTopOffset are both set equal to 0
   For n in the range of 0 to NumRegions/2−1:
      PackedRegLeft[n] is set equal to packed_reg_left[n]
      PackedRegTop[n] is set equal to packed_reg_top[n]
      PackedRegWidth[n] is set equal to packed_reg_width[n]
      PackedRegHeight[n] is set equal to packed_reg_height[n]
      ProjRegLeft[n] is set equal to proj_reg_left[n]
      ProjRegTop[n] is set equal to proj_reg_top[n]
      ProjRegWidth[n] is set equal to proj_reg_width[n]
      ProjRegHeight[n] is set equal to proj_reg_height[n]
      TransformType[n] is set equal to transform_type[n]
      PackingType[n] is set equal to packing type[n]
   For n in the range of NumRegion/2 to NumRegions−1: NIdx is set equal to (n−NumRegion/2)
      PackedRegLeft[n] is set equal to packed_reg_left[NIdx]+PackedLeftOffset
      PackedRegTop[n] is set equal to packed_reg_top[NIdx]+PackedTopOffset
      PackedRegWidth[n] is set equal to packed_reg_width[NIdx]
      PackedRegHeight[n] is set equal to packed_reg_height[NIdx]
      ProjRegLeft[n] is set equal to proj_reg_left[NIdx]+ProjLeftOffset
      ProjRegTop[n] is set equal to proj_reg_top[NIdx]+ProjTopOffset
      ProjRegWidth[n] is set equal to projreg_width[NIdx]
      ProjRegHeight[n] is set equal to proj_regheight[NIdx]
      TransformType[n] is set equal to transform_type[NIdx]
      PackingType[n] is set equal to packing_type[NIdx]
         If RegionWisePackingFlag is equal to 1, the following applies for each packed region n in the range of 0 to NumRegions−1, inclusive:
For each sample location (xPackedPicture, yPackedPicture) belonging to the n-th packed region with PackingType[n] equal to 0 (i.e., with rectangular region-wise packing), the following applies:
   The corresponding sample location (xProjPicture, yProjPicture) of the projected picture is derived as follows:
      x is set equal to xPackedPicture−PackedRegLeft[n].
      y is set equal to yPackedPicture−PackedRegTop[n].
      Clause 5.4 [of Choi] is invoked with x, y, PackedRegWidth[n], PackedRegHeight[n], ProjRegWidth[n] ProjRegHeight[n], TransformType[n], offsetX and offsetY as inputs, and the output is assigned to sample location (i, j).
      xProjPicture is set equal to ProjRegLeft[n]+i.
      When StereoFlag is equal to 0 or TopBottomFlag is equal to 1, and when xProjPicture is greater than or equal to proj_picture_width, xProjPicture is set equal to xProjPicture−proj_picture_width.
      When SideBySideFlag is equal to 1, the following applies:
         When ProjRegLeft[n] is less than proj_picture_width/2 and xProjPicture is greater than or equal to proj_picture_width/2, xProjPicture is set equal to xProjPicture−proj_picture_width/2.
         When ProjRegLeft[n] is greater than or equal to proj_picture_width/2 and xProjPicture is greater than or equal to proj_picture_width, xProjPicture is set equal to xProjPicture−proj_picture_width/2.
      yProjPicture is set equal to ProjRegTop[n]+j.
   Clause 7.2.1.3 [of Choi] is invoked with xProjPicture, yProjPicture, MonoPicWidth, and MonoPicHeight as inputs, and the outputs indicating the sphere coordinates and the constituent frame index (for frame-packed stereoscopic video) for the luma sample location (xPackedPicture, yPackedPicture) belonging to the n-th packed region in the decoded picture.
      Otherwise, the following applies for each sample location (x, y) within the decoded picture:
xProjPicture is set equal to x+offsetX.
yProjPicture is set equal to y+offsetY.
Clause 7.2.1.3 [of Choi] is invoked with xProjPicture, yProjPicture, MonoPicWidth, and MonoPicHeight as inputs, and the outputs indicating the sphere coordinates and the constituent frame index (for frame-packed stereoscopic video) for the sample location (x, y) within the decoded picture.

It should be noted that with respect to the notation used in Boyce, the process for mapping of luma sample locations within a region-wise packed picture to sphere coordinates relative to the global coordinate axes may be specified as follows:

This clause specifies the semantics of luma sample locations within a region-wise packed picture to sphere coordinates relative to the global coordinate axes.

This clause uses variables HorDiv1, VerDiv1, RotationFlag, StereoFlag, TopBottomFlag, SideBySideFlag, ConstituentPicWidth, ConstituentPicHeight, and RegionWisePackingFlag that are derived specific to the type of the decoded picture for which the corresponding region-wise packed picture this clause is applied to. offsetX is set equal to 0.5 and offsetY is set equal to 0.5.

The values of the variables NumRegions, PackedRegLeft[n], PackedRegTop[n], PackedRegWidth[n], PackedRegHeight[n], ProjRegLeft[n], ProjRegTop[n], ProjPictureWidth[n], ProjPictureHeight[n], TrasnformType[n], PackingType[n] are set as follows:
If constituent_picture_matching_regions is equal to 0: NumRegions is set equal to num_packed_regions and for n in the range of 0 to NumRegions−1: PackedRegLeft[n] is set equal to packed_region_left[n], PackedRegTop[n] is set equal to packed_region_top[n], PackedRegWidth[n] is set equal to packed_region_width[n], PackedRegHeight[n] is set equal to packed_region_height[n], ProjRegLeft[n] is set equal to proj_region_left[n], ProjRegTop[n] is set equal to proj_region_top[n], ProjRegWidth[n] is set equal to proj_region_width[n], ProjRegHeight[n] is set equal to proj_region_height[n], TransformType[n] is set equal to transform_type[n], PackingType[n] is set equal to packing_type[n]
If constituent_picture_matching_regions is equal to 1: NumRegions is set equal to 2*num_packed_regions.
   When TopBottomFlag is set equal to 1 following variables are set: ProjLeftOffset and PackedLeftOffset are both set equal to 0, ProjTopOffset is set equal to proj_picture_height/2 and PackedTopOffset is set equal to packed_picture_height/2
   When SideBySideFlag is set equal to 1 following variables are set: ProjLeftOffset is set equal to proj_picture_width/2, PackedLeftOffset is set equal to packed_picture_width/2, ProjTopOffset and PackedTopOffset are both set equal to 0
   For n in the range of 0 to NumRegions/2−1: PackedRegLeft[n] is set equal to packed_region_left[n], PackedRegTop[n] is set equal to packed_region_top[n], PackedRegWidth[n] is set equal to packed region_width[n], PackedRegHeight[n] is set equal to packed region height[n], ProjRegLeft[n] is set equal to proj_region_left[n], ProjRegTop[n] is set equal to proj_region_top[n], ProjRegWidth[n] is set equal to proj_region_width[n], ProjRegHeight[n] is set equal to proj_region_height[n], TransformType[n] is set equal to transform_type[n], PackingType[n] is set equal to packing_type[n]
   For n in the range of NumRegion/2 to NumRegions−1: NIdx is set equal to (n−NumRegion/2), PackedRegLeft[n] is set equal to packed region left[NIdx]+PackedLeftOffset, PackedRegTop[n] is set equal to packed region_top[NIdx]+PackedTopOffset, PackedRegWidth[n] is set equal to packed_region_width[NIdx], PackedRegHeight[n] is set equal to packed_region height[NIdx], ProjRegLeft[n] is set equal to proj_region_left[NIdx]+ProjLeftOffset, ProjRegTop[n] is set equal to proj_region_top[NIdx]+ProjTopOffset, ProjRegWidth[n] is set equal to proj_region_width[NIdx], ProjRegHeight[n] is set equal to proj region height[NIdx], TransformType[n] is set equal to transform type[NIdx], PackingType[n] is set equal to packing_type[NIdx]
      If RegionWisePackingFlag is equal to 1, the following applies for each packed region n in the range of 0 to NumRegions−1, inclusive:
For each sample location (xPackedPicture, yPackedPicture) belonging to the n-th packed region with PackingType[n] equal to 0 (i.e., with rectangular region-wise packing), the following applies:
The corresponding sample location (xProjPicture, yProjPicture) of the projected picture is derived as follows:
x is set equal to xPackedPicture−PackedRegLeft [n].
y is set equal to yPackedPicture−PackedRegTop [n].
Clause D.3.41.5.4 is invoked with x, y, PackedRegWidth[n], PackedRegHeight[n], ProjRegWidth[n], ProjRegHeight[n], TransformType[n], offsetX and offsetY as inputs, and the output is assigned to sample location (i, j).
xProjPicture is set equal to ProjRegLeft [n]+i.
When StereoFlag is equal to 0 or TopBottomFlag is equal to 1, and when xProjPicture is greater than or equal to proj_picture_width, xProjPicture is set equal to xProjPicture−proj_picture_width.
When SideBySideFlag is equal to 1, the following applies:
When ProjRegLeft [n] is less than proj_picture_width/2 and xProjPicture is greater than or equal to proj_picture_width/2, xProjPicture is set equal to xProjPicture−proj_picture_width/2.
When ProjRegLeft [n] is greater than or equal to proj_picture_width/2 and xProjPicture is greater than or equal to proj_picture_width, xProjPicture is set equal to xProjPicture−proj_picture_width/2.
yProjPicture is set equal to ProjRegTop[n]+j.
Clause D.3.41.5.6 of [Boyce] is invoked with xProjPicture, yProjPicture, ConstituentPicWidth, and ConstituentPicHeight as inputs, and the outputs indicating the sphere coordinates and the constituent picture index (for frame-packed stereoscopic video) for the luma sample location (xPackedPicture, yPackedPicture) belonging to the n-th packed region in the decoded picture.
   Otherwise, the following applies for each sample location (x, y) within the region-wise packed picture:
xProjPicture is set equal to x+offsetX.
yProjPicture is set equal to y+offsetY.
Clause D.3.4.15.6 [of Boyce] is invoked with xProjPicture, yProjPicture, ConstituentPicWidth, and ConstituentPicHeight as inputs, and the outputs indicating the sphere coordinates and the constituent picture index (for frame-packed stereoscopic video) for the sample location (x, y) within the region-wise packed picture.

Thus, destination device 120 represents an example of a device configured to determine values for variables corresponding to packed regions and/or projected regions based according to the techniques described herein.

As describe above, in Choi constituent_picture_matching_regions is included in RegionWisePackingStruct. In one example, according to the techniques described herein RegionWisePackingStruct, may be based on the following semantics:

Semantics

constituent_picture_matching_regions equal to 1 specifies that the projected region information, packed region information, and guard band region information in this box apply individually to each constituent picture and that the packed picture and the projected picture have the same stereoscopic frame packing format indicated by the StereoVideoBox. constituent_picture_matching_regions equal to 0 specifies that the projected region information, packed region information, and guard band region information in this box apply to the projected picture. When StereoFlag is equal to 0, constituent_picture_matching_regions shall be equal to 0.

NOTE 1: For the stereoscopic content that uses equivalent region-wise packing for the constituent pictures, setting this flag equal to 1 allows more compact signalling of region-wise packing information.

num_regions specifies the number of packed regions for which the projected region information, packed region information, and guard band region information are indicated. Value 0 is reserved. When constituent_picture_matching_regions is equal to 1, the total number of packed regions is equal to 2*num_regions and the information in RectRegionPacking(i) and in guard_band_flag[i], packing_type[i], left_gb_width[i], right_gb_width[i], top_gb_height[i], bottom_gb_height[i], gb_not_used_for_pred_flag[i], and gb_type[i] applies to each constituent picture of the projected picture and the packed picture.

proj_picture_width and proj_picture_height specify the width and height, respectively, of the projected picture, in relative projected picture sample units. proj_picture_width and proj_picture_height shall both be greater than 0.

NOTE 2: The same sampling grid, width, and height are used for the luma sample array and the chroma sample arrays of the projected picture.

packed_picture_width and packed_picture_height specify the width and height, respectively, of the packed picture, in relative packed picture sample units. packed_picture_width and packed_picture_height shall both be greater than 0. packed_picture_width and packed_picture_height shall have such values that packed_reg_width[i], packed_reg_height[i], packed_reg_top[i], and packed_reg_left[i], represent integer horizontal and vertical coordinates of luma sample units within the decoded pictures or the composition pictures, when RegionWisePackingBox is contained in ProjectedOmniVideoBox or SubPictureCompositionBox, respectively.

guard_band_flag[i] equal to 0 specifies that the i-th packed region does not have a guard band. guard band_flag[i] equal to 1 specifies that the i-th packed region has a guard band.
packing_type[i] specifies the type of region-wise packing. packing_type[i] equal to 0 indicates rectangular region-wise packing. Other values are reserved. left_gb_width[i] specifies the width of the guard band on the left side of the i-th packed region in relative packed picture sample units. When the decoded picture has 4:2:0 or 4:2:2 chroma format, left_gb_width[i] shall correspond to an even number of luma samples within the decoded picture or the composition picture, when RegionWisePackingBox is contained in ProjectedOmniVideoBox or SubPictureCompositionBox [as specified in Choi], respectively.
right_gb_width[i] specifies the width of the guard band on the right side of the i-th packed region in relative packed picture sample units. When the decoded picture has 4:2:0 or 4:2:2 chroma format, right_gb_width[i] shall correspond to an even number of luma samples within the decoded picture or the composition picture, when RegionWisePackingBox is contained in ProjectedOmniVideoBox or SubPictureCompositionBox, respectively.
top_gb_height[i] specifies the height of the guard band above the i-th packed region in relative packed picture sample units. When the decoded picture has 4:2:0 chroma format, top_gb_height[i] shall correspond to an even number of luma samples within the decoded picture or the composition picture, when RegionWisePackingBox is contained in ProjectedOmniVideoBox or SubPictureCompositionBox, respectively. bottom_gb_height[i] specifies the height of the guard band below the i-th packed region in relative packed picture sample units. When the decoded picture has 4:2:0 chroma format, bottom_gb_height[i] shall correspond to an even number of luma samples within the decoded picture or the composition picture, when RegionWisePackingBox is contained in ProjectedOmniVideoBox or SubPictureCompositionBox, respectively.
When guard_band_flag[i] is equal to 1, left_gb_width[i], right_gb_width[i], top_gb_height[i], or bottom_gb_height[i] shall be greater than 0.
The i-th packed region as specified by this RegionWisePackingStruct shall not overlap with any other packed region specified by the same RegionWisePackingStruct or any guard band specified by the same RegionWisePackingStruct.
The guard bands associated with the i-th packed region, if any, as specified by this RegionWisePackingStruct shall not overlap with any packed region specified by the same RegionWisePackingStruct or any other guard bands specified by the same RegionWisePackingStruct.
gb_not_used_for_pred_flag [i] equal to 0 specifies that the guard bands may or may not be used in the inter prediction process. gb_not_used_for_pred_flag[i] equal to 1 specifies that the sample values of the guard bands are not in the inter prediction process.
NOTE 3: When gb_not_used_for_pred_flag[i] is equal to 1, the sample values within guard bands in decoded pictures can be rewritten even if the decoded pictures were used as references for inter prediction of subsequent pictures to be decoded. For example, the content of a packed region can be seamlessly expanded to its guard band with decoded and re-projected samples of another packed region.
gb_type[i][j] specifies the type of the guard bands for the i-th packed region as follows, with j equal to 0, 1, 2, and 3 indicating that the semantics below apply to the left, right, top, and bottom edge, respectively, of the packed region:
gb_type[i][j] equal to 0 specifies that the content of the guard bands in relation to the content of the packed regions is unspecified. gb_type[i][j] shall not be equal to 0, when gb_not_used_for_pred_flag [i] is equal to 0.
gb_type[i][j] equal to 1 specifies that the content of the guard bands suffices for interpolation of sub-pixel values within the packed region and less than one pixel outside of the boundary of the packed region.
   NOTE 4: gb_type[i][j] equal to 1 can be used when the boundary samples of a packed region have been copied horizontally or vertically to the guard band.
gb_type[i][j] equal to 2 specifies that the content of the guard bands represents actual image content at quality that gradually changes from the picture quality of the packed region to that of the spherically adjacent packed region.
gb_type[i][j] equal to 3 specifies that the content of the guard bands represents actual image content at the picture quality of the packed region.
gb_type[i][j] values greater than 3 are reserved. proj_reg_width[i], proj_reg_height[i], proj_reg_top[i] and proj_reg_left[i] are indicated in relative projected picture sample units.
   proj_reg_width[i] specifies the width of the i-th projected region.
   proj_reg_height[i] specifies the height of the i-th projected region.
   proj_reg_top[i] and proj_reg_left[i] specify the top sample row and the left-most sample column, respectively, of the i-th projected region, either in the projected picture (when constituent picture_matching_regions is equal to 0) or in the constituent picture of the projected picture (when constituent_picture_matching_regions is equal to 1). The values of proj_reg_width[i], proj_reg_height[i], proj_reg_top[i], and proj_reg_left[i] are constrained as follows:
If StereoFlag is equal to 0:
   proj_reg_width[i] shall be in the range of 1 to proj_picture_width, inclusive.
   proj_reg_height[i] shall be greater than 0.
   proj_reg_height[i] and proj_reg_top[i] shall be constrained such that proj_reg_height[i]+proj_reg_top[i]−1 is less than proj_picture_height.
   proj_reg_top[i] and proj_reg_left[i] shall be in the range from 0, inclusive, indicating the top-left corner of the projected picture, to proj_picture_height−1, inclusive, and proj_picture_width−1, inclusive, respectively.
When StereoFlag is equal to 1, the following applies:
   proj_reg_width[i] shall be in the range of 1 to-proj_picture_width/HorDiv1, inclusive.
   proj_reg_height[i] shall be in the range of 1 to-proj_picture_height/VerDiv1, inclusive.
   If proj_reg_left[i] is less than proj_picture_width/HorDiv1, proj_reg_width[i] and proj_reg_left[i] shall be constrained such that projreg_width[i]+proj_reg_left[i]−1 is less than proj_picture_width/HorDiv1.
   Otherwise (proj_reg_left[i] is greater than or equal to proj_picture_width/HorDiv1), proj_reg_width[i] and projreg_left[i] shall be constrained such that projreg_width[i]+proj_reg_left[i]−proj_picture_width/HorDiv1−1 is less than proj_picture_width/HorDiv1.
   If proj_reg_top[i] is less than proj_picture_height/VerDiv1 then proj_reg_height[i] and proj_reg_top[i] shall be constrained such that proj_reg_height[i]+proj_reg_top[i]−1 is less than proj_picture_height/VerDiv1.
   Otherwise (i.e. when proj_reg_top[i] is greater than or equal to proj_picture_height/VerDiv1) then proj_reg_height[i] and proj_reg_top[i] shall be constrained such that proj_reg_height[i]+proj_reg_top[i]−proj_picture_height/VerDiv1−1 is less than proj_picture_height/VerDiv1.
   When constituent_picture_matching_regions is equal to 0 (and StereoFlag is equal to 1), the following applies:
      proj_reg_height[i] and proj_reg_top[i] shall be constrained such that proj_reg_height[i]+proj_reg_top[i]−1 is less than proj_picture_height.
      proj_reg_top[i] and proj_reg_left[i] shall be in the range from 0, inclusive, indicating the top-left corner of the projected picture, to proj_picture_height−1, inclusive, and proj_picture_width−1, inclusive, respectively.
   When constituent_picture_matching_regions is equal to 1 (and StereoFlag is equal to 1), the following applies:
      The values of proj_reg_top[i] and proj_reg_left[i] shall be in the range from 0, inclusive, to proj_picture_height/VerDiv1−1, inclusive, and proj_picture_width/HorDiv1−1, inclusive, respectively.
      proj_reg_width[i] and projreg_left[i] shall be constrained such that proj_reg_width[i]+proj_reg_left[i]−1 is less than proj_picture_width/HorDiv1.
      proj_reg_height[i] and proj_reg_top[i] shall be constrained such that proj_reg_height[i]+proj_reg_top[i]−1 is less than proj_picture_height/VerDiv1.
         transform_type[i] specifies the rotation and mirroring that is applied to the i-th packed region to remap it to the i-th projected region. When transform_type[i] specifies both rotation and mirroring, rotation is applied before mirroring for converting sample locations of a packed region to sample locations of a projected region. The following values are specified:
         0: no transform
         1: mirroring horizontally
         2: rotation by 180 degrees (counter-clockwise)
         3: rotation by 180 degrees (counter-clockwise) before mirroring horizontally
         4: rotation by 90 degrees (counter-clockwise) before mirroring horizontally
         5: rotation by 90 degrees (counter-clockwise)
         6: rotation by 270 degrees (counter-clockwise) before mirroring horizontally
         7: rotation by 270 degrees (counter-clockwise)
         NOTE 5: Clause 5.4 [of Choi] specifies the semantics of transform_type[i] for converting a sample location of a packed region in a packed picture to a sample location of a projected region in a projected picture.
         packed_reg_width[i], packed_reg_height[i], packed_reg_top[i], and packed_reg_left[i] specify the width, height, the top sample row, and the left-most sample column, respectively, of the i-th packed region, either within the packed picture (when constituent_picture_matching_regions is equal to 0) or within each constituent picture of the packed picture (when constituent_picture_matching_regions is equal to 1). packed_reg_width[i], packed_reg_height[i], packed_reg_top[i], and packed_reg_left[i] are indicated in relative packed picture sample units.
         The values of packed_reg_width[i], packed_reg_height[i], packed_reg_top[i], and packed_reg_left[i] are constrained as follows:
packed_reg_width[i] and packed_reg_height[i] shall be greater than 0.
packed_reg_top[i] and packed_reg_left[i] shall in the range from 0, inclusive, indicating the top-left corner of the packed picture, to packed_picture_height−1, inclusive, and packed_picture_width−1, inclusive, respectively.
If constituent_picture_matching_regions is equal to 0, the following applies:
   The sum of packed_reg_width[i] and packed_reg_left[i] minus 1 shall be less than packed_picture_width.
   The sum of packed_reg_height[i] and packed_reg_top[i] minus 1 shall be less than packed_picture_height.
Otherwise (constituent_picture_matching_regions is equal to 1), the following applies:
   The sum of packed_reg_width[i] and packed_reg_left[i] minus 1 shall be less than packed_picture_width/HorDiv1.
   The sum of packed_reg_height[i] and packed_reg_top[i] minus 1 shall be less than packed_picture_height/VerDiv1.
When the decoded picture has 4:2:0 or 4:2:2 chroma format, packed_reg_left[i] shall correspond to an even horizontal coordinate value of luma sample units within the decoded picture or the composition picture, when RegionWisePackingBox is contained in ProjectedOmniVideoBox or SubPictureCompositionBox, respectively.
When the decoded picture has 4:2:0 or 4:2:2 chroma format, and packed_reg_width[i] shall correspond to an even number of luma samples within the decoded picture or the composition picture, when RegionWisePackingBox is contained in ProjectedOmniVideoBox or SubPictureCompositionBox, respectively.
When the decoded picture has 4:2:0 chroma format, packed_reg_top[i] shall correspond to an even vertical coordinate value of luma sample units within the decoded picture or the composition picture, when RegionWisePackingBox is contained in ProjectedOmniVideoBox or SubPictureCompositionBox, respectively.
When the decoded picture has 4:2:0 chroma format, packed_reg_height[i] shall correspond to an even number of luma samples within the decoded picture or the composition picture, when RegionWisePackingBox is contained in ProjectedOmniVideoBox or SubPictureCompositionBox, respectively.
   In a similar manner, in one example, with respect to Table 3, the following constraints may be applied to the values of proj_region_width[i], proj_region_height[i], proj_region_top[i], and proj_region_left[i] in a Region-wise packing SEI message: The values of proj_region_width[i], proj_region_height[i], proj_region_top[i], and proj_region_left[i] are constrained as follows:
If StereoFlag is equal to 0:
   proj_region_width[i] shall be in the range of 1 to proj_picture_width, inclusive.
   proj_region_height[i] shall be greater than 0.
   proj_region_height[i] and proj_region_top[i] shall be constrained such that proj_region_height[i]+proj_region_top[i]−1 is less than proj_picture_height.
   proj_region_top[i] and proj_region_left[i] shall be in the range from 0, inclusive, indicating the top-left corner of the projected picture, to proj_picture_height−1, inclusive, and proj_picture_width−1, inclusive, respectively.
When StereoFlag is equal to 1, the following applies:
   proj_region_width[i] shall be in the range of 1 to proj_picture_width/HorDiv1, inclusive.
   proj_region_height[i] shall be in the range of 1 to proj_picture_height/VerDiv1, inclusive.
   If proj_region_left[i] is less than proj_picture_width/HorDiv1, proj_region_width[i] and proj_region_left[i] shall be constrained such that proj_region_width[i]+proj_region_left[i]−1 is less than proj_picture_width/HorDiv1.
   Otherwise (proj_region_left[i] is greater than or equal to proj_picture_width/HorDiv1), proj_region_width[i] and proj_region_left[i] shall be constrained such that proj_region_width[i]+proj_region_left[i]−proj_picture_width/HorDiv1−1 is less than proj_picture_width/HorDiv1.
   If proj_region_top[i] is less than proj_picture_height/VerDiv1 then proj_region_height[i] and proj_region_top[i] shall be constrained such that proj_region_height[i]+proj_region_top[i]−1 is less than proj_picture_height/VerDiv1.
   Otherwise (i.e. when proj_region_top[i] is greater than or equal to proj_picture_height/VerDiv1) then proj_region_height[i] and proj_region_top[i] shall be constrained such that proj_region_height[i]+proj_region_top[i]−proj_picture_height/VerDiv1−1 is less than proj_picture_height/VerDiv1.
   When constituent_picture_matching_regions is equal to 0 (and StereoFlag is equal to 1), the following applies:
      proj_region_height[i] and proj_region_top[i] shall be constrained such that proj_region_height[i]+proj_region_top[i]−1 is less than proj_picture_height.
      proj_region_top[i] and proj_region_left[i] shall be in the range from 0, inclusive, indicating the top-left corner of the projected picture, to proj_picture_height−1, inclusive, and proj_picture_width−1, inclusive, respectively.
   When constituent_picture_matching_reg is equal to 1, the following applies:
      The values of proj_region_top[i] and proj_region_left[i] shall be in the range from 0, inclusive, to proj_picture_height/VerDiv1−1, inclusive, and proj_picture_width/HorDiv1−1, inclusive, respectively.
      proj_region_width[i] and proj_region_left[i] shall be constrained such that proj_region_width[i]+proj_region_left[i]−1 is less than proj_picture_width/HorDiv1.
      proj_region_height[i] and proj_region_top[i] shall be constrained such that proj_region_height[i]+proj_region_top[i]−1 is less than proj_picture_height/VerDiv1.

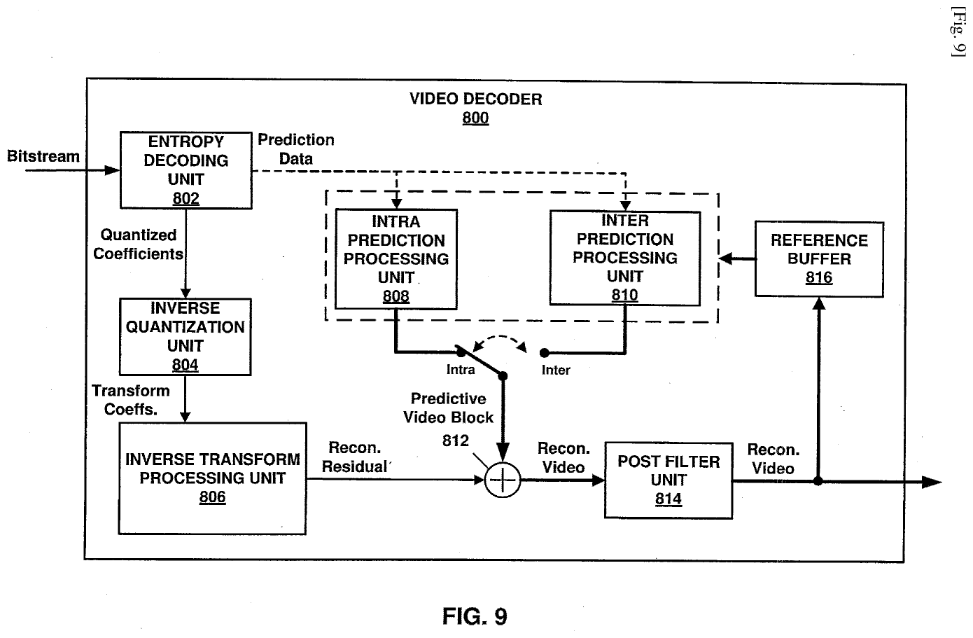

FIG. 9 is a block diagram illustrating an example of a video decoder that may be configured to decode video data according to one or more techniques of this disclosure. In one example, video decoder 800 may be configured to decode transform data and reconstruct residual data from transform coefficients based on decoded transform data. Video decoder 800 may be configured to perform intra prediction decoding and inter prediction decoding and, as such, may be referred to as a hybrid decoder. In the example illustrated in FIG. 9, video decoder 800 includes an entropy decoding unit 802, inverse quantization unit 804, transform coefficient processing unit 806, intra prediction processing unit 808, inter prediction processing unit 810, summer 812, post filter unit 814, and reference buffer 816. Video decoder 800 may be configured to decode video data in a manner consistent with a video coding system. It should be noted that although example video decoder 800 is illustrated as having distinct functional blocks, such an illustration is for descriptive purposes and does not limit video decoder 800 and/or sub-components thereof to a particular hardware or software architecture. Functions of video decoder 800 may be realized using any combination of hardware, firmware, and/or software implementations.

As illustrated in FIG. 9, entropy decoding unit 802 receives an entropy encoded bitstream. Entropy decoding unit 802 may be configured to decode syntax elements and quantized coefficients from the bitstream according to a process reciprocal to an entropy encoding process. Entropy decoding unit 802 may be configured to perform entropy decoding according any of the entropy coding techniques described above. Entropy decoding unit 802 may determine values for syntax elements in an encoded bitstream in a manner consistent with a video coding standard. In the example illustrated in FIG. 9, inverse quantization unit 804 and transform coefficient processing unit 806 receive quantized coefficient values and transform coefficients and output reconstructed residual data.

Referring again to FIG. 9, reconstructed residual data may be provided to summer 812 Summer 812 may add reconstructed residual data to a predictive video block and generate reconstructed video data. A predictive video block may be determined according to a predictive video technique (i.e., intra prediction and inter frame prediction). Intra prediction processing unit 808 may be configured to receive intra prediction syntax elements and retrieve a predictive video block from reference buffer 816. Reference buffer 816 may include a memory device configured to store one or more frames of video data. Intra prediction syntax elements may identify an intra prediction mode, such as the intra prediction modes described above. Inter prediction processing unit 810 may receive inter prediction syntax elements and generate motion vectors to identify a prediction block in one or more reference frames stored in reference buffer 816. Inter prediction processing unit 810 may produce motion compensated blocks, possibly performing interpolation based on interpolation filters. Identifiers for interpolation filters to be used for motion estimation with sub-pixel precision may be included in the syntax elements. Inter prediction processing unit 810 may use interpolation filters to calculate interpolated values for sub-integer pixels of a reference block. Post filter unit 814 may be configured to perform filtering on reconstructed video data. For example, post filter unit 814 may be configured to perform deblocking and/or Sample Adaptive Offset (SAO) filtering, e.g., based on parameters specified in a bitstream. Further, it should be noted that in some examples, post filter unit 814 may be configured to perform proprietary discretionary filtering (e.g., visual enhancements, such as, mosquito noise reduction). As illustrated in FIG. 9, a reconstructed video block may be output by video decoder 800. In this manner, video decoder 800 may be configured to generate reconstructed video data according to one or more of the techniques described herein.

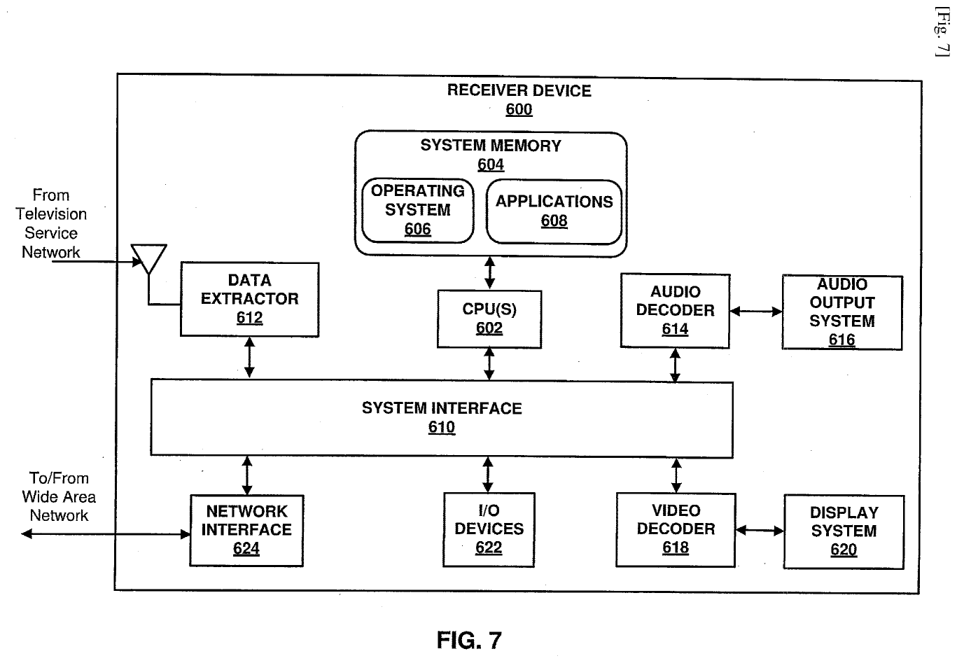

Referring again to FIG. 1, destination device 120 may include a receiver device. FIG. 7 is a block diagram illustrating an example of a receiver device that may implement one or more techniques of this disclosure. That is, receiver device 600 may be configured to parse a signal based on the semantics described above and/or perform mapping of mapping sample locations in a packed frame to angular coordinates of a projection structure. Receiver device 600 is an example of a computing device that may be configured to receive data from a communications network and allow a user to access multimedia content, including a virtual reality application. In the example illustrated in FIG. 7, receiver device 600 is configured to receive data via a television network, such as, for example, television service network 404 described above. Further, in the example illustrated in FIG. 7, receiver device 600 is configured to send and receive data via a wide area network. It should be noted that in other examples, receiver device 600 may be configured to simply receive data through a television service network 404. The techniques described herein may be utilized by devices configured to communicate using any and all combinations of communications networks.

As illustrated in FIG. 7, receiver device 600 includes central processing unit(s) 602, system memory 604, system interface 610, data extractor 612, audio decoder 614, audio output system 616, video decoder 618, display system 620, I/O device(s) 622, and network interface 624. As illustrated in FIG. 7, system memory 604 includes operating system 606 and applications 608. Each of central processing unit(s) 602, system memory 604, system interface 610, data extractor 612, audio decoder 614, audio output system 616, video decoder 618, display system 620, I/O device(s) 622, and network interface 624 may be interconnected (physically, communicatively, and/or operatively) for inter-component communications and may be implemented as any of a variety of suitable circuitry, such as one or more microprocessors, digital signal processors (DSPs), application specific integrated circuits (ASICs), field programmable gate arrays (FPGAs), discrete logic, software, hardware, firmware or any combinations thereof. It should be noted that although receiver device 600 is illustrated as having distinct functional blocks, such an illustration is for descriptive purposes and does not limit receiver device 600 to a particular hardware architecture. Functions of receiver device 600 may be realized using any combination of hardware, firmware and/or software implementations.

CPU(s) 602 may be configured to implement functionality and/or process instructions for execution in receiver device 600. CPU(s) 602 may include single and/or multi-core central processing units. CPU(s) 602 may be capable of retrieving and processing instructions, code, and/or data structures for implementing one or more of the techniques described herein. Instructions may be stored on a computer readable medium, such as system memory 604.

System memory 604 may be described as a non-transitory or tangible computer-readable storage medium. In some examples, system memory 604 may provide temporary and/or long-term storage. In some examples, system memory 604 or portions thereof may be described as non-volatile memory and in other examples portions of system memory 604 may be described as volatile memory. System memory 604 may be configured to store information that may be used by receiver device 600 during operation. System memory 604 may be used to store program instructions for execution by CPU(s) 602 and may be used by programs running on receiver device 600 to temporarily store information during program execution. Further, in the example where receiver device 600 is included as part of a digital video recorder, system memory 604 may be configured to store numerous video files.

Applications 608 may include applications implemented within or executed by receiver device 600 and may be implemented or contained within, operable by, executed by, and/or be operatively/communicatively coupled to components of receiver device 600. Applications 608 may include instructions that may cause CPU(s) 602 of receiver device 600 to perform particular functions. Applications 608 may include algorithms which are expressed in computer programming statements, such as, for-loops, while-loops, if-statements, do-loops, etc. Applications 608 may be developed using a specified programming language. Examples of programming languages include, Java™, Jini™, C, C++, Objective C, Swift, Perl, Python, PhP, UNIX Shell, Visual Basic, and Visual Basic Script. In the example where receiver device 600 includes a smart television, applications may be developed by a television manufacturer or a broadcaster. As illustrated in FIG. 7, applications 608 may execute in conjunction with operating system 606. That is, operating system 606 may be configured to facilitate the interaction of applications 608 with CPUs(s) 602, and other hardware components of receiver device 600. Operating system 606 may be an operating system designed to be installed on set-top boxes, digital video recorders, televisions, and the like. It should be noted that techniques described herein may be utilized by devices configured to operate using any and all combinations of software architectures.

System interface 610 may be configured to enable communications between components of receiver device 600. In one example, system interface 610 comprises structures that enable data to be transferred from one peer device to another peer device or to a storage medium. For example, system interface 610 may include a chipset supporting Accelerated Graphics Port (AGP) based protocols, Peripheral Component Interconnect (PCI) bus based protocols, such as, for example, the PCI Express™ (PCIe) bus specification, which is maintained by the Peripheral Component Interconnect Special Interest Group, or any other form of structure that may be used to interconnect peer devices (e.g., proprietary bus protocols).

As described above, receiver device 600 is configured to receive and, optionally, send data via a television service network. As described above, a television service network may operate according to a telecommunications standard. A telecommunications standard may define communication properties (e.g., protocol layers), such as, for example, physical signaling, addressing, channel access control, packet properties, and data processing. In the example illustrated in FIG. 7, data extractor 612 may be configured to extract video, audio, and data from a signal. A signal may be defined according to, for example, aspects DVB standards, ATSC standards, ISDB standards, DTMB standards, DMB standards, and DOCSIS standards. Data extractor 612 may be configured to extract video, audio, and data, from a signal. That is, data extractor 612 may operate in a reciprocal manner to a service distribution engine.

Data packets may be processed by CPU(s) 602, audio decoder 614, and video decoder 618. Audio decoder 614 may be configured to receive and process audio packets. For example, audio decoder 614 may include a combination of hardware and software configured to implement aspects of an audio codec. That is, audio decoder 614 may be configured to receive audio packets and provide audio data to audio output system 616 for rendering. Audio data may be coded using multi-channel formats such as those developed by Dolby and Digital Theater Systems. Audio data may be coded using an audio compression format. Examples of audio compression formats include Motion Picture Experts Group (MPEG) formats, Advanced Audio Coding (AAC) formats, DTS-HD formats, and Dolby Digital (AC-3) formats. Audio output system 616 may be configured to render audio data. For example, audio output system 616 may include an audio processor, a digital-to-analog converter, an amplifier, and a speaker system. A speaker system may include any of a variety of speaker systems, such as headphones, an integrated stereo speaker system, a multi-speaker system, or a surround sound system.

Video decoder 618 may be configured to receive and process video packets. For example, video decoder 618 may include a combination of hardware and software used to implement aspects of a video codec. In one example, video decoder 618 may be configured to decode video data encoded according to any number of video compression standards, such as ITU-T H.262 or ISO/IEC MPEG-2 Visual, ISO/IEC MPEG-4 Visual, ITU-T H.264 (also known as ISO/IEC MPEG-4 Advanced video Coding (AVC)), and High-Efficiency Video Coding (HEVC). Display system 620 may be configured to retrieve and process video data for display. For example, display system 620 may receive pixel data from video decoder 618 and output data for visual presentation. Further, display system 620 may be configured to output graphics in conjunction with video data, e.g., graphical user interfaces. Display system 620 may comprise one of a variety of display devices such as a liquid crystal display (LCD), a plasma display, an organic light emitting diode (OLED) display, or another type of display device capable of presenting video data to a user. A display device may be configured to display standard definition content, high definition content, or ultra-high definition content.

I/O device(s) 622 may be configured to receive input and provide output during operation of receiver device 600. That is, I/O device(s) 622 may enable a user to select multimedia content to be rendered. Input may be generated from an input device, such as, for example, a push-button remote control, a device including a touch-sensitive screen, a motion-based input device, an audio-based input device, or any other type of device configured to receive user input. I/O device(s) 622 may be operatively coupled to receiver device 600 using a standardized communication protocol, such as for example, Universal Serial Bus protocol (USB), Bluetooth, ZigBee or a proprietary communications protocol, such as, for example, a proprietary infrared communications protocol.

Network interface 624 may be configured to enable receiver device 600 to send and receive data via a local area network and/or a wide area network. Network interface 624 may include a network interface card, such as an Ethernet card, an optical transceiver, a radio frequency transceiver, or any other type of device configured to send and receive information. Network interface 624 may be configured to perform physical signaling, addressing, and channel access control according to the physical and Media Access Control (MAC) layers utilized in a network. Receiver device 600 may be configured to parse a signal generated according to any of the techniques described above. In this manner, receiver device 600 represents an example of a device configured parse one or more syntax elements including information associated with a virtual reality application.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Moreover, each functional block or various features of the base station device and the terminal device used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

Various examples have been described. These and other examples are within the scope of the following claims.

1-6. (canceled)

7. A method of determining information associated with projected pictures that are packed region-wise, the method comprising:
receiving a supplemental enhancement information message that enables remapping of color samples onto projected pictures; and
parsing a syntax element included in the supplemental enhancement information message,
wherein the syntax element has a value indicating one of:
projected region information and packed region information apply individually to each constituent picture; or
projected region information and packed region information apply to a projected picture.

8. The method of claim 7, wherein when projected region information and packed region information apply individually to each constituent picture, the packed picture and the projected picture have the same stereoscopic frame packing format.

9. The method of claim 7, further comprising:
parsing a syntax element specifying the width of a packed picture; and
parsing a syntax element specifying the height of a packed picture.

10. The method of claim 9, wherein the syntax element specifying the width of a packed picture is a packed picture width syntax element and the syntax element specifying the height of a packed picture is a packed picture height syntax element.

11. A device comprising one or more processors configured to:
parse a syntax element included in a received supplemental enhancement information message that enables remapping of color samples onto projected pictures, the syntax element indicating whether the information applies individually to each constituent picture.

12. The device of claim 11, wherein the syntax element has a value indicating one of:
projected region information and packed region information apply individually to each constituent picture; or
projected region information and packed region information apply to a projected picture.

13. The device of claim 11, wherein when projected region information and packed region information apply individually to each constituent picture, the packed picture and the projected picture have the same stereoscopic frame packing format.

14. The device of claim 11, wherein the one or more processors are further configured to:
parse a syntax element specifying the width of a packed picture; and
parse a syntax element specifying the height of a packed picture.

15. The device of claim 14, wherein the syntax element specifying the width of a packed picture is a packed picture width syntax element and the syntax element specifying the height of a packed picture is a packed picture height syntax element.
